(19) United States
(12) Patent Application Publication
(10) Pub. No.: US 2001/0053992 A1
(43) Pub. Date: Dec. 20, 2001

(54) Industrial complex, sevice center, method for managing industrial complex, service regulation system, and shared operational information regulation system

(76) Inventors: Keisuke Eto, Tokuyama-shi (JP); Kenichi Hirasawa, Ichihara-shi (JP)

Correspondence Address: FLYNN, THIEL, BOUTELL & TANIS, P.C., 2026 Rambling Road, Kalamazoo, MI, 49008-1699, US

(21) Appl. No.: 09/820,183

(22) Filed: Mar. 28, 2001

(30) Foreign Application Priority Data
Mar. 31, 2000 (JP) 2000-098637
Mar. 31, 2000 (JP) 2000-098638
Mar. 31, 2000 (JP) 2000-098639
Apr. 13, 2000 (JP) 2000-112637

(51) Int. Cl. G06F 17/60

(52) U.S. Cl. 705/7

(57) ABSTRACT

In an industrial complex composed of a plurality of plants, at least one of the plants is provided with a service section, specifically, analyzers, for providing a service for at least one of the plants in accordance with the request from at least one of the plants. A virtual service center, that is, a virtual analysis center, is composed of the analyzers and a server.

### BACKGROUND OF THE INVENTION

1. Field of the Invention

The present invention relates to an industrial complex composed of a plurality of plants, for example, a petrochemical complex, in which materials, facilities, labors, etc., are shared or interchanged, a service center, a method for managing the industrial complex, a service regulation system, and a shared operational information regulation system.

2. Description of the Related Art

In the industrial complex in which apparatuses and facilities are assembled and organically combined with each other, factions produced from a crude oil by distillation and refinement, for example, a naphtha fraction, are raw materials for petrochemical products, such as ethylene and propylene, produced by cracking.

In the conventional industrial complexes, these materials have been transferred to other companies combined with pipelines in order to decrease the physical distribution costs.

In the conventional industrial complexes, the transfer of raw materials through pipelines and the transfer of intermediate products have been rationalized to some extent, although the industrial complexes have not been rationalized as a whole.

In particular, other facilities, materials, operational information, etc., were not shared, so that each business entity had to ensure, control, or operate by oneself. In this case, there were problems in that since each business entity had to ensure facilities, etc., with allowance, of the waste due to duplication of facilities, etc., and since those facilities were used only in each of the business entities, the working ratios of the facilities cannot be increased.

Regarding basic supplies, for example, water, electric power, steam, and nitrogen and oxygen, each of the business entities had to keep its own inventories to some extent and had to ensure the basic supplies on the safe side, so that surplus basic supplies or surplus accessories were always provided in practice.

### SUMMARY OF THE INVENTION

The present invention is intended to solve the aforementioned problems. In order to decrease the waste due to the duplication of facilities, basic supplies, etc., among the business entities, to decrease costs as a whole, and to improve the working ratios of the facilities, etc., the present invention is constituted as the following description.

[Industrial Complex]

An industrial complex according to the present invention is the industrial complex composed of a plurality of plants and include a service center providing services for at least one of the aforementioned plants in accordance with the requests therefrom.

Accordingly, since the service center for providing services for at least one of the plants in accordance with the requests therefrom is provided, each of the plants does not need to be provided with all facilities required for the operations thereof. Therefore, the waste due to the duplication of facilities, etc., can be decreased among the business entities, so that the costs as a whole can be decreased and the working ratios of the facilities, etc., can be improved.

In the industrial complex according to the present invention, the aforementioned service center may be independent of the aforementioned plants.

As a consequence, the service center is not likely to be affected by various restrictions in each plant, so as to exhibit optimum service center functions in the industrial complex.

In the industrial complex according to the present invention, the aforementioned service center may include at least one service section provided in the aforementioned plants.

This is economical because the service section constituting the service center is provided in at least one plant, and the existing facility can be used at the place as it is, so that the aforementioned service can be realized without providing a new service section at another place.

The aforementioned industrial complex preferably includes a plurality of service sections sharing the mutually complementary function.

Accordingly, since the plurality of service sections share the mutually complementary function, by these service sections being distributed among the plants, the burden for providing the service sections can be leveled out among the plants, and risks in disasters, etc., can be diversified.

In the aforementioned industrial complex, it is preferable that a virtual service center is composed of the aforementioned plurality of service sections sharing the mutually complementary function.

Accordingly, the burden for providing the service sections can be leveled out among the plants and risks in disasters, etc., can be diversified.

In the industrial complex according to the present invention, the aforementioned service preferably includes at least one of the supply of materials, the provision of facilities, and the provision of labors.

Accordingly, each plant can be provided with materials, facilities, and labors, so that the waste can be minimized in wide areas.

In the industrial complex according to the present invention, the aforementioned service center preferably includes a request reception device for receiving requests of services from each of the plants through an information network formed among the plants.

Accordingly, since the requests of services from each of the plant can be received through the information network, the reception operations can be promptly and efficiently performed without timing constraints. Therefore, the service provision based on the reception of the request can be promptly performed.

Herein, the information network means a communication device for mutually transferring the information between the different plants in the industrial complex. As the communication device, fiber optics, cable circuits using analog signals or digital signals, public networks, or radio circuits using analog signals or digital signals may be used, and furthermore, Internet, modems, and telephone lines may be used. In particular, from the viewpoint of the transmission speed, fiber optics is preferable. As the system, a server client system, etc., can be appropriately used. By using the aforementioned information network, even when the plants and the service provider are distributed, the information exchange between each of the plants and the service provider can be performed in real time, so that the service can be promptly provided without timing constraints.

In the industrial complex according to the present invention, the aforementioned service center preferably includes an announcement device for announcing the business information regarding the services to each plant through the information network formed among the plants.

Accordingly, since the business information of the service center is announced to each plant through the information network, each plant can confirm the business information and can request services. By announcing the business information, for example, business contents, e.g., analysis items in an analysis center, business days and hours, fees (costs), working statuses, and delivery times, the users in each plant can confirm the business information and can request necessary services at desired dates and times.

The industrial complex according to the present invention preferably includes a publishing device for publishing the service provision status in at least one of the plants to the other plants.

Accordingly, since the service provision status, for example, the status of surplus or shortage in capacity, of at least one of the plants is published to the other plants, the interchange between the plant publishing the service provision status and another plant can be performed. Therefore, the waste due to the duplication of facilities, basic supplies, etc., can be decreased among the plants, so that the costs as a whole can be decreased and the working ratios of the facilities, etc., can be improved.

In the aforementioned industrial complex, the publishing device is constituted on the information network formed among the plants.

Accordingly, since the publishing device is constituted on the information network, every plant can arbitrarily confirm the published information, so that the interchange can be promptly performed.

The industrial complex according to the present invention preferably includes an intermediating device for intermediating a service supplement between the plant publishing the service provision status and another plant.

Accordingly, the service supplement between the plant publishing the service provision status and another plant can be performed through the intermediating device. In this case, the intermediating device may intermediate the service provision for the first plant to request the service supplement. In the case in which a plurality of plants request a service provision side for service supplement, the intermediating device may intermediate the service provision for the highest bidder among the plants requesting the service supplement. In the case in which a plurality of plants request the service provision to a plant requesting the service supplement, the intermediating device may intermediate the service provision from the lowest bidder among the plants requesting the provision of the service.

In the aforementioned industrial complex, the intermediating device is preferably constituted on the information network formed among the plants.

Accordingly, since the intermediating device is constituted on the information network, every plant can arbitrarily request the intermediary regarding the published information, so that the interchange can also be promptly performed.

[Service Center]

A service center according to the present invention is provided in an industrial complex composed of a plurality of plants, which provides a service for at least one of the plants in accordance with a request therefrom.

Accordingly, in a manner similar to that in the aforementioned industrial complex including the service center, the waste due to the duplication of the facilities, etc., can be decreased among the business entities, so that the costs in the business entities as a whole can be decreased and the working ratios of the facilities, etc., can be improved.

[Method for Managing Industrial Complex]

A method for managing an industrial complex according to the present invention is the method for managing the industrial complex composed of a plurality of plants, which preferably includes the steps of publishing the service provision status in at least one of the plants to the other plants, and intermediating a service supplement between the plant publishing the service provision status and another plant.

Accordingly, the effects similar to those in the aforementioned industrial complex including the publishing device and the intermediating device can be exhibited.

[Service Regulation System]

A service regulation system according to the present invention is the service regulation system for the industrial complex composed of a plurality of plants, which includes an announcement device for announcing the business information regarding the services to each of the aforementioned plants through an information network formed among the plants, a booking registration device for receiving a booking of a request for the service, and an announcement device for announcing the booking registration status to each user.

Accordingly, the business information regarding the services is announced to each plant through the information network formed among the plants, and when a user in each plant requests a booking of a service requirement based thereon, the booking is registered with the booking registration device. Then, since the booking registration status is announced to each user, the users can confirm the booking registration status and can book the service provision on the desired date and time. Therefore, the service provision side can make a future plan for providing the services, so as to improve the working ratio of the facilities, etc., and to make the working ratios of the facilities, etc., optimum from the viewpoint of the cost or the schedule.

The service regulation system according to the present invention is preferably further provided with a calculator for calculating costs caused by the use of the aforementioned services.

Accordingly, since the costs caused by the use of the services are automatically calculated, the burden of handling the billings can be decreased.

The service regulation system according to the present invention is preferably further provided with a calculator for calculating the optimum working status of the facility based on the booking data registered by the aforementioned booking registration device.

Accordingly, in the case in which desired booking date and time are overlapped, etc., it is possible to make the working status of the facility, etc., optimum from the viewpoint of the cost or the schedule based on the booking data.

The service regulation system according to the present invention is the mutual service regulation system for the industrial complex composed of the plurality of plants, which includes a registration device for receiving the registration of the service provision status in at least one of the plants, a booking registration device for receiving a booking of the request for the service, a publishing device publishing the aforementioned registered service provision status and the booking registration status to each plant, and a calculator for calculating the optimum working status of the facility based on the booking data registered by the booking registration device.

Accordingly, a user in each plant can confirm the published service provision status and the booking registration status, and can request the booking of the service requirement. When the user requests the booking of the service requirement, the booking is registered with the booking registration device, and the optimum working status of the facility is calculated based on the registered booking data. Therefore, the service provision side can make a future plan for providing the service, so as to improve the working ratio of the facility, etc., and furthermore, to make the working status of the facility, etc., optimum from the viewpoint of the cost or the schedule.

The service regulation system according to the present invention is further provided with a calculator for calculating costs caused by the use of the aforementioned service.

Accordingly, since the costs caused by the use of the service are automatically calculated, the burden of handling the billings can be decreased.

Shared Operational Information Regulation System

A shed operational information regulation system for an industrial complex according to the present invention includes a registration on device for registering the operational information of the aforementioned business entities, and an announcement device for announcing the operational information registered with the registration device to each user.

Herein, the operational information means, for example, (1) the information regarding the facilities, (2) the information regarding the basic supplies, that is, water, electric power, steam, nitrogen, oxygen, etc., (3) the information regarding the raw materials and the wastes, (4) the information regarding the conservation materials and the office supplies, and (5) the information regarding the security and the fireguard. The raw material is a concept embracing every raw material for manufacturing products. Naphtha, reformed oils, kerosene, etc., manufactured from raw materials, and petrochemical basic products manufactured from naphtha, for example, ethylene, propylene, butadiene, benzene, toluene, and xylene, are raw materials for petrochemical derivatives.

As the registration device, devices having common magnetic memories, etc., as memory devices, in which registrations are performed through the server client systems or the modems, devices using the network, etc., can be mentioned.

As the announcement device, similarly to the registration device, devices in which announcements are performed through the server client systems or the modems, or devices using the network can be mentioned.

According to this system, since the operational information of each of the business entities is announced to users, the users can grasp the operational information of each of the business entities. Therefore, (1) the information regarding the facilities, (2) the information regarding the basic supplies, (3) the information regarding the raw materials and the wastes, (4) the information regarding the conservation materials and the office supplies, and (5) the information and facilities regarding the security and the fireguard, etc., possessed by each of the business entities can be shared and interchanged, so that the waste due to the duplication of the facilities, basic supplies, etc., among the business entities can be decreased, and the costs as a whole can be decreased while the working ratios of facilities, etc., can be improved.

In the shared operational information regulation system according to the present invention, at least one of the aforementioned registration and the announcement is preferably performed using an information network.

Herein, the information network means a data communication device for mutually transferring the information between different plants in the industrial complex. As the communication device, fiber optics, cable circuits using analog signals or digital signals, public networks, or radio circuits using analog signals or digital signals, and furthermore, internet, modems, and telephone lines may be used. In particular, from the viewpoint of the transmission speed, the fiber optics and the radio circuits are preferable, and from the viewpoint of the security, the fiber optics is more preferable. As the system, the server client system, etc., can be preferably used.

By using the aforementioned system, even when the business entities and the receiving side of the registration of the operational information of the business entities are distributed, the information exchange therebetween can be performed in real time, so that the registration and the announcement can be promptly performed without timing constraints.

In the shared operational information regulation system according to the present invention, the working statuses of the facilities possessed by each of the aforementioned business entities are preferably registered as the operational information.

Herein, as the facilities, for example, docks, tankers, storage facilities such as tanks, analyzers, waste disposal apparatuses, can be mentioned.

According to this system, since the working statuses of the facilities possessed by each of the business entities are registered and announced to the users, the users can confirm the announced working statuses of the facilities and can request the uses of the facilities. Therefore the facilities possessed by each of the business entities can be used efficiently and the working ratios of the facilities can also be improved.

In the shared operational information regulation system according to the present invention, the aforementioned registration device preferably includes a fame relay network provided among the business entities, so that measured values of the working statuses of the facilities possessed by each of the business entities are registered through the frame relay network.

This system uses the frame relay network provided among the business entities, so that this system is economical compared to general public networks and is superior in performance and quality.

The shared operational information regulation system according to the present invention is preferably further provided with a remote monitoring device for supervising the working statuses of the facilities possessed by each of the business entities at a remote site.

According to this system, since the working statuses of the facilities possessed by each of the business entities can be monitored at a remote site, the facilities can be efficiently monitored with no operator being deployed in the neighborhood of the facilities.

In the shared operational information regulation system according to the present invention, the working statuses of the facilities possessed by each of the business entities monitored with the remote monitoring device are preferably announced to each of the aforementioned business entities through the aforementioned announcement device as the image information.

According to this system, since the working statuses of the facilities monitored with the remote monitoring device are shared as the image information, everyone can precisely grasp the working statuses of the facilities as the images.

In the shared operational information regulation system according to the present invention, the aforementioned information network is preferably the optical cable.

According to this system, since the information network is composed of the fiber optics, larger amounts of information can be transmitted in high speed compared to that of the frame relay.

### BRIEF DESCRIPTION OF THE DRAWINGS

FIG. 1 is a diagram of an industrial complex system according to a first embodiment of the present invention;

FIG. 2 is a diagram of an analysis center work flow according to the first and a eighth embodiments of the present invention;

FIG. 3 is a diagram of booking tables provided in the analysis center according to the first embodiment of the present invention;

FIG. 4 is a diagram of a display screen announcing the business contents of the analysis center according to the first embodiment of the present invention;

FIG. 5 is a diagram of a display screen announcing the booking registration status of the analysis center according to the first embodiment of the present invention;

FIG. 6 is a flow diagram of a booking procedure of the analysis center according to the first embodiment of the present invention;

FIG. 7 is a diagram of an industrial complex system according to a second and a tenth embodiments of the present invention;

FIG. 8 is a diagram of an industrial complex system according to a third embodiment of the present invention;

FIG. 9 is a diagram of an industrial complex system including virtual centers according to other embodiments of the present invention;

FIG. 10 is a diagram of an industrial complex system according to a fourth embodiment of the present invention;

FIG. 11 is a diagram of an industrial complex system according to a fifth and a ninth embodiments of the present invention;

FIG. 12 is a diagram of an industrial complex system according to a sixth embodiment of the present invention;

FIG. 13 is a diagram of booking tables according to the sixth and the eighth embodiments of the present invention;

FIG. 14 is a flow diagram of a booking procedure according to the sixth and the eighth embodiments of the present invention;

FIG. 15 is a diagram of an industrial complex system according to a seventh embodiment of the present invention;

FIG. 16 is a diagram of an industrial complex system according to the eighth embodiment of the present invention;

FIG. 17 is a diagram of booking tables of an analyzer according to the eighth embodiment of the present invention;

FIG. 18 is a flow diagram of a booking procedure of an analyzer according to the eighth embodiment of the present invention

### DESCRIPTION OF THE PREFERRED EMBODIMENTS

An embodiment of the present invention will be described below with reference to attached drawings.

In the following explanations of the embodiments, the same constituents are designated by the same reference numerals and explanations thereof are omitted or simplified.

First Embodiment

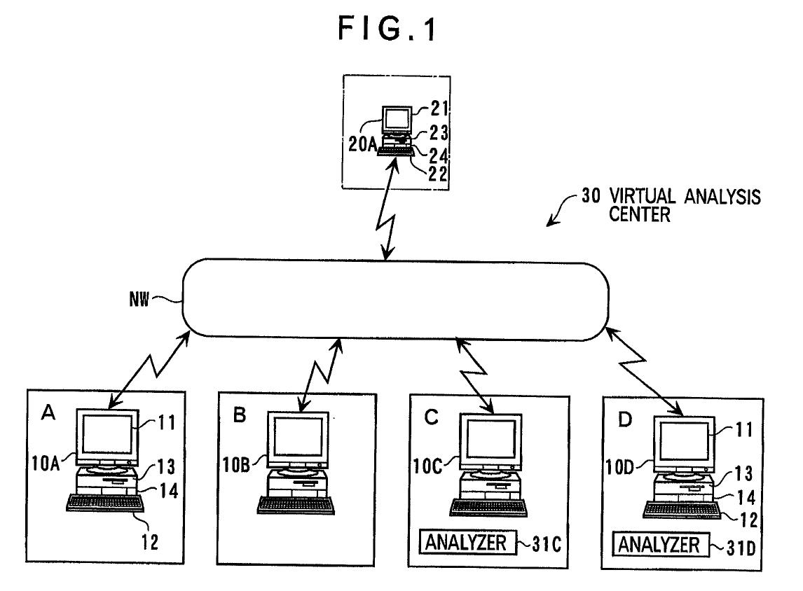

FIG. 1 shows a first embodiment. The first embodiment is an example of an industrial complex including a virtual analysis center. This industrial complex is provided with a plurality of business entities A, B, C, D assembled in a predetermined area, a server 20A, and an information network NW connecting therebetween.

In each of the business entities A, B, C, D, a plant is installed, although not shown in the drawing, and teals 10A, 10B, 10C, and 10D, respectively, for exchanging the information with other business entities (plants) A to D and the server 20A through the information network NW are deployed. Each of the terminals 10A to 10D is provided with a display device 11, an input device 12, a data processing device 14 including a memory device 13, etc.

At least one of these business entities (plants) A to D, specifically, two business entities (plants) C and D in the present embodiment, include service sections, specifically, analyzers 31C and 31D, respectively, which provide the services for at least one of the business entities (plaits) A to D based on the request thereof.

The server 20A is for exchanging the information with the terminals 10A to 10D deployed in the business entities (plants) A to D in order to regulate the aforementioned analyzers 31C and 31D, and is provided with a display device 21, an input device 22, a data processing device 24 including a memory device 23, etc. The server 20A may be deployed in either the business entity (plants) C or D including the analyzers 31C and 31D, although the server 20A may be deployed in another arbitrary place. The server 20A and the analyzers 31C and 31D share the functions of complementing each other, and constitute a virtual analysis center as a virtual service center.

Herein, the aforementioned data processing device 24 is provided with a request reception device for receiving the requests for services from the business entities (plants) A to D through the information network NW, an announcement device for announcing the business information regarding the services to each of the business entities (plants) A to D, a booking registration device for receiving the booking of request for the service reception, an announcement device for announcing the booking registration status to each user, and a calculator for calculating fees (costs) due to the use of the service, etc. In the memory device 23 as a storage medium, the programs regulating the systems performed by each of the aforementioned devices are stored.

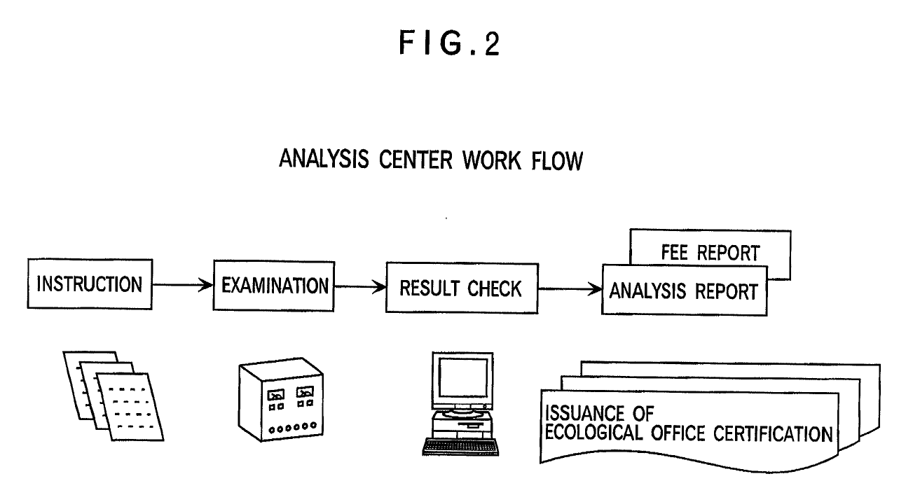

After the request reception device receives a request for a service from the business entities (plants) A to D through the information network NW, for example, as shown in FIG. 2, an examination is performed based on an instruction, the resulting data are checked, and the calculation result of the fees (costs) and the data are reported.

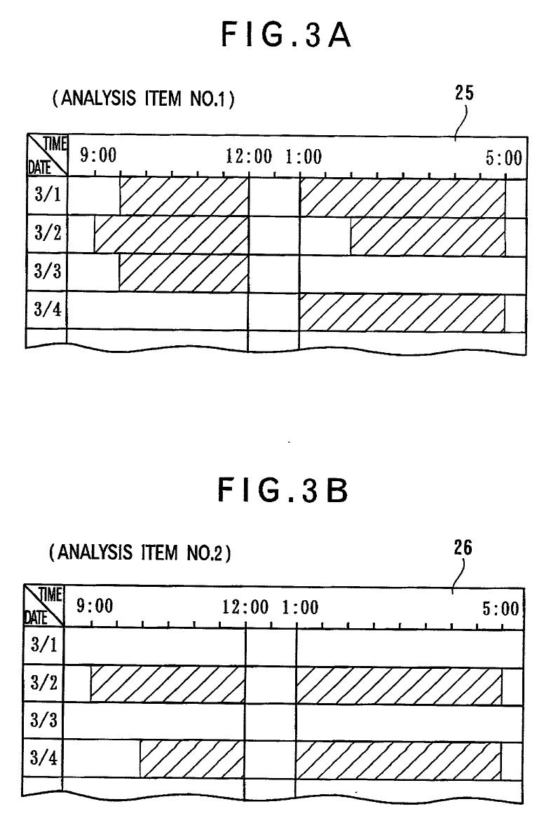

Regarding each of the analysis items, that is, all analysis items including analysis items using specific analyzer, etc., and other analysis items, the booking registration can be performed beforehand. For example, as shown in FIGS. 3A and 3B, the booking tables 25 and 26 are prepared for the booking registrations of an analytical item No. 1 and an analytical item No. 2, respectively. In FIG. 3, the diagonally shaded areas indicate the time periods in which bookings has been registered.

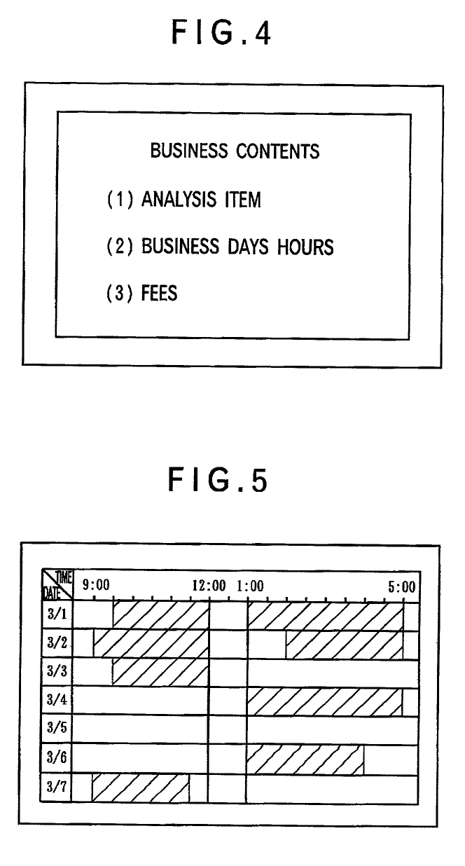

The announcement device announces the information of the virtual analysis center 30, for example, the analysis items (examination items), the business days and hours, the fees (costs), the working statuses, and the delivery times, as the business information or the registered contents based on the booking of the service reception (the booking registration status of the booking tables 25 and 26) through the information network NW to each of the aforementioned business entities (plants) A to D. Therefore, as shown in FIG. 4 and FIG. 5, the business information and the booking registration status can be confirmed in real time with the terminals 10A to 10D deployed in the business entities (plants) A to D, so that the request for the analysis and the booking of the request for the analysis can be thereby performed.

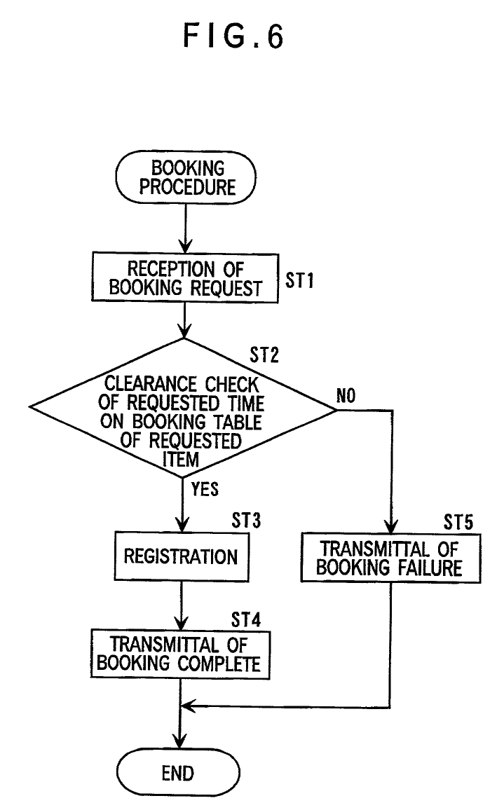

As shown in FIG. 6, when the booking registration device receives the booking request (ST1) from one of the business entities (plants) A to D, a clearance check on the booking tables 25 and 26 with the appointed item and time (ST2) is performed.

If there is a clearance, the booking registration is performed, that is, the booking is registered in the corresponding column of the booking tables 25 and 26 of the appointed analysis items (ST3). Subsequently, a message of the booking completion is transmitted to one of the business entities (plants) A to D which has re the booking (ST4).

On the other hand, if there is no clearance, a message of the booking failure is transmitted to one of the business entities (plants) A to D which has requested the booking (ST5). In this case, one of the business entities (plants) A to D which has received the message of the booking failure confirms the booking registration status, and requests another booking.

According to the aforementioned first embodiment, the following effects can be expected.

(1) Regarding the routine business among the examination and the analysis business, since the facilities possessed by each of the business entities (plants) A to D can be centralized, the necessary number as a whole can be decreased, so that the waste can be decreased and the working ratio per facility can be improved by effective use of the surplus capacity.

(2) Regarding the advanced technology, for example, the microanalysis, e.g., the analysis of hazardous substances, expensive apparatuses and machines can be shared with every business entities in the industrial complex, so that the cost merit is increased. There are merits in that the analysis can be performed with small numbers of analysts and the analytical technique can be improved. In addition, regarding the specific analysis, an expert employee transferred from an experienced business entity can take charge of the analysis, so that the efficiency can be improved.

(3) The cost merit due to the collective purchase of common reagents and common accessories are remarkable, and the cost merit due to regulation ease and decrease in inventory are remarkable.

(4) In particular, regarding the environmental analysis, since the analysis items are common to the business entities (plants) A to D, the merit of the centralization is remarkable. Furthermore, the connection with the government and municipal offices is possible at all times through the information network NW, so that, in particular, the results of the environmental analysis can be reported to the government and municipal offices in real time.

(5) Since the business information of the virtual analysis center 30 or the registered contents based on the booking of the service reception (the booking registration status) are announced through the information network NW to each of the aforementioned business entities (plants) A to D, the business information and the booking registration status can be confirmed in real time with the terminals 10A to 10D in the business entities (plants) A to D, so that the request for the analysis and the booking of the request for the analysis can be thereby performed.

(6) Since the fees (costs) due to the analysis are automatically calculated, the burden of handling the billings can be decreased. Normally, the fees are paid to the business entity taking charge of the analysis. Since the business entities (plants) A to D use the mutual facilities, by calculating costs at regular intervals counterbalancing the costs among the business entities (plants) A to D, the handling business regarding the payment can be decreased. That is, the business due to give and receive of cash is decreased and the paperwork is simplified. In addition, regarding the cost information, if a device for directly connecting to the bank is provided, by the automatic deposition into the bank account, the paperwork is further simplified.

If the delivery date can be automatically calculated based on the working status of the facility, and if each user can confirm this at all times, that is, if a delivery date calculator is provided, it is convenient for the users.

It is better to calculate the optimum working status of the facility based on the booking data registered by the booking registration device. That is, a device for calculating the working status of the facility is preferably provided.

Second Embodiment

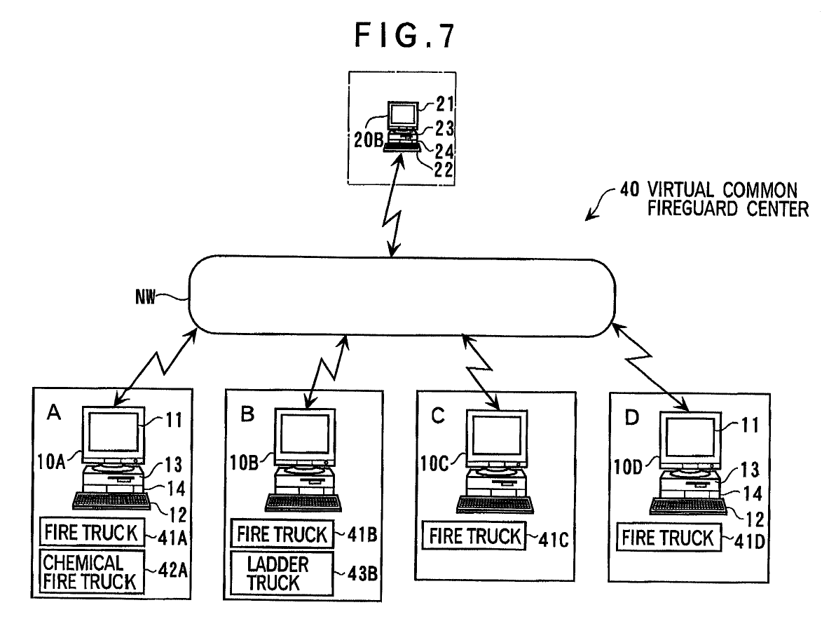

FIG. 7 shows a second embodiment. The second embodiment is an example of an industrial complex including a virtual common fireguard center 40. In this industrial complex, the virtual common fireguard center 40 as a vi service center is composed of the fire fighting facilities as the service sections deployed in each of the business entities plants) A to D and a server 20B, deployed in one of the aforementioned business entities (plants) A to D or at another place, for regulating the aforementioned fire fighting facilities.

Specifically, a fire truck 41A and a chemical fire truck 42A are deployed in the business entity (plant) A, a fire truck 41B and a ladder truck 43B are deployed in the business entity (plant) B, a fire truck 41C is deployed in the business entity (plant) C, and a fire truck 41D is deployed in the business entity (plant) D.

The contents of the fighting facilities deployed each of the business entities (plants) A to D are registered beforehand in a memory device 23 of the server 20B. When the status of the disaster (the place of the fire, the kinds and the number of the fire trucks required, etc.) is inputted into the server. 20B from the alarm system, although not shown in the drawing, the server 20B commands the fighting facilities deployed each of the business entities (plants) A to D and reports to the government and municipal offices (fire department).

For example, when an occurrence of a chemical fire in the business entity (plant) C is inputted into the server 20B through the alarm system, the server 20B commands the business entity (plants) A to call out the chemical fire truck 42A, and commands the other business entities (plants) B to D to call out the required number of fire trucks through the information network NW based on the inputted place of the fire, and the kinds and the number of the fire trucks required. At the same time, the server 20B reports to the government and municipal offices (fire department). According to the aforementioned second embodiment, the following effects can be expected.

(1) Since the fire fighting facilities required for the industrial complex as a whole are ensured, and each of the business entities (plants) A to D does not need to ensure the fire fighting facilities for its own use, the number of the fire fighting facilities as a whole can be decreased. Therefore, the waste due to the duplication of the fire fighting facilities among the business entities (plants) A to D can be decreased, so that the costs can be decreased.

(2) Since these fire-fighting facilities are distributed among the business entities (plants) A to D, this system can be realized by using the existing facilities at the place as those are. That is, a new common fireguard center to centralize and put in those fire fighting facilities does not need to be constructed, so that this system can be economically realized. In addition, even if the fire fighting facilities are distributed among the business entities (plants) A to D, since these fire fighting facilities can be collectively regulated with the server 20B, the response to the disaster, for example, an occurrence of a fire, can be promptly and precisely performed.

(3) When the information of the disaster is inputted into the server 20B through the alarm system, since the server 20B commands the fighting facilities deployed each of the business entities (plants) A to D and reports to the government and municipal offices (fire department), for example, in the case in which the place of the disaster is in the neighborhood of the urban area, measures such as the refuge of the citizens can be promptly taken through the fire department. On the other hand, in the case in which the fire, etc., have occurred in the urban area, by the fire department inputting the status into the system according to the present invention, the fire fighting facilities in the present virtual common fireguard center 40 can be called out. In particular, this is advantageous in the case in which the chemical fire track is required or the distance is short.

Third Embodiment

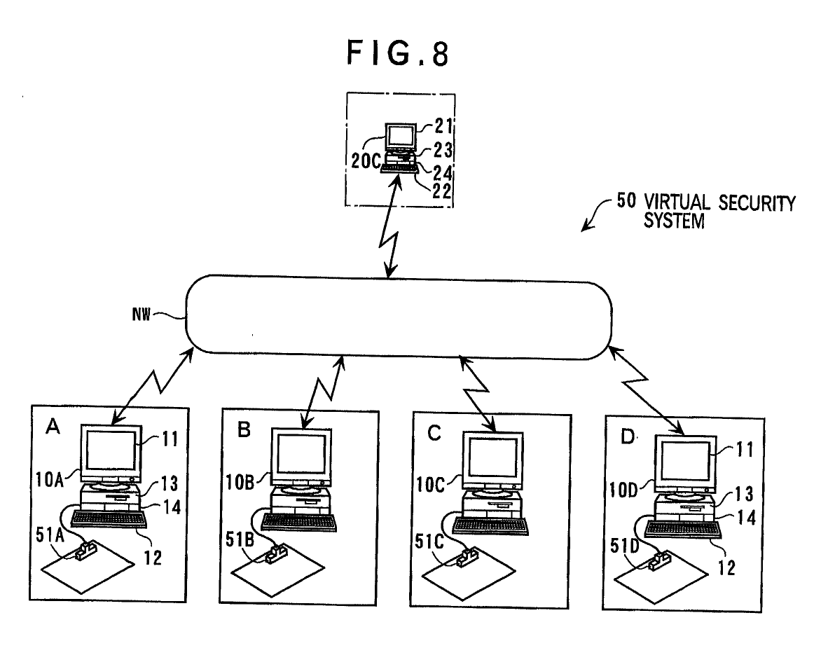

FIG. 8 shows a third embodiment. The third embodiment is an example of an industrial complex including a virtual security system 50. In this industrial complex, the virtual security system 50 as a virtual service center is composed of a visitor input device as a service section deployed in each of the business entities (plants) A to D and a server 20C, deployed in one of the aforementioned business entities (plants) A to D or at another place, for receiving the registration of the visitor inputted with the aforementioned visitor input device.

Specifically, scanners 51A to 51D, etc., for inputting visitors are provided in the business entities (plants) A to D, respectively. The visitor data inputted with the scanners 51A to 51D are registered in the server 20C.

The visitors registered in the server 20C can be confirmed in real time with the terminals 10A to 10D in the business entities (plants) A to D through the information network NW.

According to the aforementioned third embodiment, the following effects can be expected.

(1) By using this virtual security system 50, the visitors entering into the entrance of every business entity (plant) A to D can be confirmed in real time with each of the terminals 10A to 10D in the business entities (plants) A to D, so that it is convenient for the visitors.

(2) On the other hand, if the efficiency of the security business is improved by centralizing the entrances, every business entity plant) A to D does not need to ensure the security business, so that the business can be decreased as a whole. Therefore, the waste due to the duplication of the business can be decreased, so that the costs can be decreased.

### OTHER EMBODIMENTS OF THE VIRTUAL CENTER

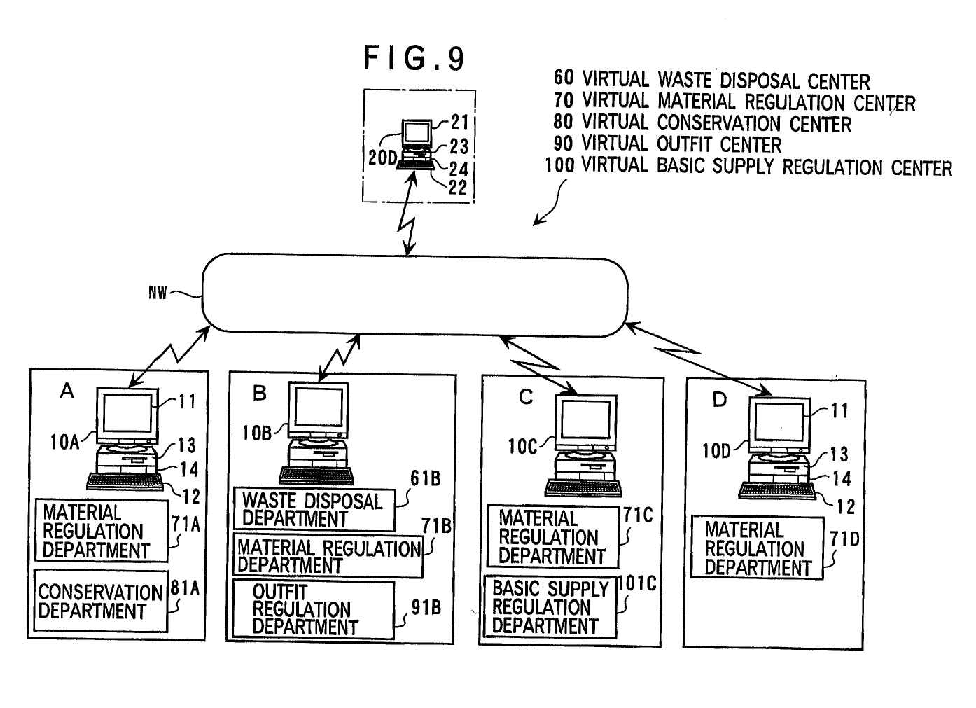

As other examples of the virtual service center, a virtual waste disposal center, a virtual material regulation center, a virtual conservation center, a virtual outfit center, a virtual basic supply regulation center, etc., can be mentioned The virtual waste disposal center 60, the virtual material regulation center 70, the virtual conservation center 80, the virtual outfit center 90, the virtual basic supply regulation center 100 will be explained below with reference to FIG. 9.

Virtual Waste Disposal Center 60

The virtual waste disposal center 60 is for the disposal of wastes discharged from the business entities (plants) A to D, and composed of a waste disposal department 61B as a service section deployed in the business entity (plant) B and a server 20D, deployed in the business entity (plant) B or at another place, for regulating the waste disposal department 61B.

The waste disposal department 61B is provided with a necessary number of the storage spaces in which the wastes discharged from the business entities (plants) A to D are classified and stored, a waste disposal facility for decomposing the classified wastes, etc.

The server 20D collects the data of the kinds and the amounts of the wastes discharged from the business entities (plants) A to D in real time, and regulates the operation of the machine (waste disposal facility) in the waste disposal department 61B.

Accordingly, the effective use of the wastes can be planned and the efficient regulation of the operation of the machine (waste disposal facility) in the waste disposal department 61B can be realized.

Virtual Material Regulation Center 70

The virtual material regulation center 70 is for the regulation of raw materials for the business entities (plants) A to D, and composed of material regulation departments 71A to 71D as service sections deployed in the business entities (plants) A to D, respectively, and a server 20D for regulating these material regulation departments 71A to 71D.

The plants in each of the business entities slants) A to D thermally decompose desulfurized naphtha, so as to produce ethylene, propylene, etc. Polyethylene, acetaldehyde, etc., are produced from ethylene. Polypropylene, isopropanol, acrylonitrile, etc., are produced from propylene.

With the terminals 10A to 10D in the business entities (plants) A to D, the kinds of the raw materials used in each of the business entities, the scheduled usages of the raw materials, the byproducts, and the kinds and the amounts of the wastes are inputted as the data in real time. Each of the business entities input the materials which can be used therein among the byproducts and the wastes of the other business entities (plants) A to D. Then, these data are inputted into the server 20D through the information network NW.

The server 20D calculates the contents and the amounts of the raw materials, the byproducts, and the wastes, so as to calculate the optimum production amount of each raw material. In addition, the server 20D calculates the contents and the amounts of the materials which are necessary for other business entities among the byproducts and the wastes, and calculates the contents and amounts of the wastes which cannot be used in any business entities (plants) A to D. The server 20D displays the amounts of the necessary raw materials, the transfer destinations among the business entities (plants) A to D and the transfer amounts of the byproducts and/or the wastes, and the amount of the final wastes.

Virtual Conservation Center 80

The dual conservation center 80 is for performing the maintenance for the business entities (plants) A to D, and composed of a conservation department 81A as a service section deployed in the business entity (plant) A and a server 20D for regulating the conservation department 81A.

The virtual conservation center 80 (server 20D) is provided with a request reception device for receiving the service requirement from the business entities (plants) A to D through the information network NW, an announcement device for announcing the business information to each of the business entities plants) A to D, a booking registration device for receiving the booking of the service reception, an announcement device for announcing the booking registration status to each user, a calculator for calculating fees (costs) due to the use of the service, etc.

After the request reception device receives a request for the conservation service from the business entities (plants) A to D through the information network NW, the conservation business is performed in accordance with the request, and the calculation of the fees (costs) is performed and the result is reported.

The announcement device announces the business information of the virtual conservation center 80 or the registered contents based on the booking of the service reception (the booking registration status) through the information network NW to each of the aforementioned business entities (plants) A to D. Therefore, the business information and the booking registration status can be confirmed in real time with the terminals 10A to 10D in the business entities (plants) A to D, so that the request for the conservation business and the booking of the conservation business can be thereby performed.

When the booking registration device receives the booking request from one of the business entities (plants) A to D, a clearance check on the appointed day and time is performed.

If there is a clearance, the booking registration is performed, that is, the booking is registered in the corresponding column of the appointed booking table. Subsequently, a message of the booking completion is transmitted to one of the business entities (plants) A to D which has requested the booking.

On the other hand, if there is no clearance, a message of the booking failure is transmitted to one of the business entities (plants) A to D which has requested the booking.

According to the deployment of the aforementioned virtual conservation center 80, the following effects can be expected

(1) Regarding the conservation business, the shutdown maintenances (SDM: the examinations performed while the operation of the plant is stopped) are performed at regular time intervals. The timings thereof are different depending on the plants, although the conservation business of the business entities (plants) A to D tends to be concentrated at a certain period in the year. By the conservation business being concentrated to the virtual conservation center 80, the virtual conservation center 80 takes charge of the SDMs of many plants, so that the business is leveled out and the business efficiency is increased.

(2) The business information of the virtual conservation center 80 or the registered contents based on the booking of the service reception (the booking registration status) is announced through the information network NW to each of the aforementioned business entities (plants) A to D. Therefore, the business information and the booking registration status can be confirmed in real time with the terminals 10A to 10D in the business entities plants) A to D, so that the request for the conservation business and the booking of the conservation business can be thereby performed.

Virtual Outfit Center 90

The virtual outfit center 90 is for regulating the materials for the constructions, the common backup supplies, the conservation implements, the office implements, etc., for the industrial complex as a whole, and composed of a outfit regulation department 91B as a service section deployed in the business entity (plant) B and a server 20D for regulating the outfit regulation department 91B.

The virtual outfit center 90 (server 20D) is provided with a request reception device for receiving the service requirement from the business entities (plants) A to D through the information network NW, an announcement device for announcing the business information to each of the business entities (plants) A to D, and a calculator for calculating the fees (costs) due to the use of the service, etc.

When the request reception device receives a request for the outfits provision service from the business entities (plants) A to D through the information network NW, the outfits are provided in accordance with the request, and thereafter, the calculation of the fees (costs) is performed and the result is reported.

The announcement device announces the business information of the virtual outfit center 90 through the information network NW to each of the aforementioned business entities (plants) A to D. Therefore, the business information can be confirmed in real time with the terminals 10A to 10D in the business entities (plants) A to D, so that the request for the outfits provision can be thereby performed According to the deployment of the aforementioned virtual outfit center 90, the following effects can be expected.

(1) According to the virtual outfit center 90, the decreases in costs due to the collective purchase and the volume purchase of the materials for the constructions, the common backup supplies, the conservation implements, the office implements, etc., for the industrial complex as a whole can be realized, and the decreases in costs due to the decrease in the inventory and the regulation ease can be realized. In addition, the decrease in the purchase paperwork cost due to the collective procurement can be realized and the purchase including delivery on a cost minimum basis can be realized.

(2) The business information of the virtual outfit center 90 is announced through the information network NW to each of the aforementioned business entities (plants) A to D. Therefore, the information regarding the inventory of the outfits, etc., can be grasped in real time with the terminals 10A to 10D in the business entities (plants) A to D, so that the order for the necessary outfits, etc., can be performed through the information network NW. Furthermore, the procurement of the outfits is possible on a 24-hour basis.

Virtual Basic Supply Regulation Center 100

The virtual basic supply regulation center 100 is for collectively regulating the basic supplies, for example, electric power, water, and steam, required for the industrial complex as a whole, and composed of a basic supply regulation department 101C as a service section deployed in the business entity (plant) C and a server 20D for regulating the basic supply regulation department 101C.

Regarding the electric power, in the vial basic supply regulation center 100, the required electric power for each of the business entities (plants) A to D, and electric power generation systems and cogeneration systems possessed by each of the business entities (plants) A to D, etc., are grasped, and the balancing with the purchased electric power and the interchanges among the business entities (plants) A to D are performed. Accordingly, the industrial complex can be regulated on a cost minimum basis as a whole.

The information of the virtual basic supply regulation center 100 is announced through the information network NW to each of the aforementioned business entities (plants) A to D. Therefore, the information regarding the usage amount of the electric power, etc., can be grasped in real time with the terminals 10A to 10D in the business entities (plants) A to D. In addition, the predicted necessary amounts of the electric power can be announced through the information network NW to the virtual basic supply regulation center 100 from each of the business entities (plants) A to D, so as to be reflected in the future electric power supply plan. Furthermore, the conjunction with an electric power company through the information network NW is possible at all times, and, for example, the sharing of the information, e.g., the information of thunder, is possible.

Regarding the water, in the virtual basic supply regulation center 100, the required amounts of the water for each of the business entities (plants) A to D, and the available amount of the water at that point, etc., are grasped, and in particular, at the time of the water shortages, in order to optimize the working state of the industrial complex as a whole, the interchanges among the business entities (plants) A to D are performed and the necessary water is allocated to each of the business entities (plants) A to D. In addition, the conjunction with dams, etc., through the information network NW is possible at all times. Therefore, each of the business entities (plants) A to D can make a production schedule in accordance with the amount of the water in the dam.

Regarding the steam, in the virtual basic supply regulation center 100, the required amounts of the steam for each of the business entities (plants) A to D, and working ratios of the boilers possessed by each of the business entities (plants) A to D, etc., are grasped, so that the interchanges among the business entities (plants) A to D are performed. Accordingly, the industrial complex can be regulated on a cost minimum basis as a whole.

The information of the virtual basic supply regulation center 100 is announced through the information network NW to each of the aforementioned business entities (plants) A to D. Therefore, the information regarding the usage amount of the steam, etc., can be grasped in real time with the terminals 10A to 10D in the business entities (plants) A to D. In addition, the predicted necessary amounts of the steam can be announced through the information network NW to the virtual basic supply regulation center 100 from each of the business entities (plants) A to D, so as to be reflected in the future steam supply plan.

Fourth Embodiment

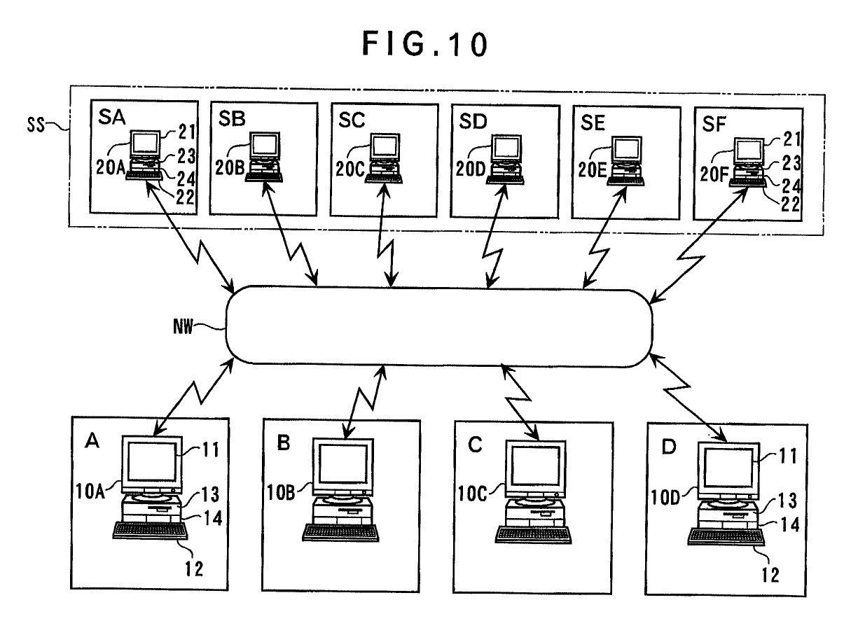

FIG. 10 shows an industrial complex according to a fourth embodiment of the present invention. This industrial complex is provided with a plurality of business entities A, B, C, D assembled in a predetermined area, a general service center SS including a plurality of service centers and independent of each of the business entities, and an information network NW connecting those.

In each of the business entities A to D, a plant is deployed, although not shown in the drawing, and terminals 10A, 10B, 10C, and 10D, respectively, for exchanging the information with other business entities (plants) A to D and the general service center SS through the information network NW, are deployed. Each of the terminals 10A to 10D is provided with a display device 11, an input device 12, a data processing device 14 including a memory device 13, etc.

General Service Center SS

In the general service center SS, a plurality of service centers providing services to the aforementioned business entities A to D in accordance with the requests of one of the business entities A to D, specifically, an analysis center SA, a customs affairs center SB, a conservation center SC, an outfit center SD, a basic supply regulation center SE, and a waste recycle center SF, are deployed.

These centers SA to SF constituting the general service center SS may be deployed at one place, although may be distributed. In these centers SA to SF, servers 20A, 20B, 20C, 20D, 20E, and 20F, respectively, for exchanging the information with the terminals 10A to 10D deployed in the business entities (plants) A to D, are deployed. Each of the servers 20A to 20F is provided with a display device 21, an input device 22, a data processing device 24 including a memory device 23, etc. Herein, since the data processing device 24 is similar to that in the aforementioned first embodiment, explanations thereof are omitted.

Analysis Center SA

The analysis center SA is deployed in the form in which the analysis departments of each of the business entities A to D are centralized.

The analysis center SA is provided with necessary numbers of analyzers, analytical instruments, reagents, furniture, etc., required for each of the business entities A to D constituting the industrial complex system. Furthermore, the analysis center SA is provided with a request reception device for receiving the service requirement from the business entities (plants) A to D through the information network NW, an announcement device for announcing the business information to each of the business entities (plants) A to D, a booking registration device receiving a booking of the service reception, an announcement device for announcing the booking registration status to each user, a calculator for calculating the fees (costs) due to the use of the service, etc.

Herein, since the request reception device, the announcement device, the booking registration device, and the calculator are similar to those of the virtual analysis center 30 in the aforementioned first embodiment, explanations thereof are omitted.

According to the deployment of the aforementioned analysis center SA, effects similar to the effects (1) to (5) in the aforementioned first embodiment can be expected.

Customs Affairs Center SB

The customs affairs center SB is deployed in order to centralize the customs business of each of the business entities A to D and to perform the customs business at one place.

In the customs affairs center SB, the industrial complex is treated as one business entity, and the imports and the exports are grasped on the entirety of the industrial complex basis. Specifically, since among the imported raw materials, the customs formalities are not necessary regarding the portion corresponding to the products to be exported, the raw materials to be imported and the amounts of the products to be exported are grasped on the entirety of the industrial complex basis.

In the customs affairs center SB, the exchange of the information in real time with the tax office is possible through the information network NW. Accordingly, the efficiency of the business is improved and the status can be confirmed with ease at all times.

Conservation Center SC

The conservation center SC is deployed in the form in which the conservation businesses of performing the maintenance for each of the business entities A to D are centralized.

The conservation center SC is provided with a request reception device for receiving the service requirement from the business entities (plants) A to D through the information network NW, an announcement device for announcing the business information regarding the services to each of the business entities (plants) A to D, a booking registration device receiving a booking of service reception, an announcement device for announcing the booking registration status to each user, a calculator for calculating the fees (costs) due to the use of the service, etc.

Herein, since the request reception device, the announcement device, the booking registration device, and the calculator are similar to those of the virtual conservation center 80 in the aforementioned other embodiments of the virtual center as shown in FIG. 9, explanations thereof are omitted.

According to the deployment of the aforementioned conservation center SC, effects similar to the effects (1) and (2) in the aforementioned virtual conservation center 80 can be expected.

Outfit Center SD

The outfit center SD is deployed in order to store and regulate the raw materials, the materials for the constructions, the common backup supplies, the conservation implements, the office implements, etc., required for the industrial complex as a whole at one place.

The outfit center SD is provided with a request reception device for receiving the service requirement from the business entities (plants) A to D through the information network NW, an announcement device for announcing the business information to each of the business entities (plants) A to D, a calculator for calculating the fees (costs) due to the use of the service, etc. Herein, since the request reception device, the announcement device, and the calculator are similar to those of the virtual outfit center 90 in the aforementioned other embodiments of the virtual center as shown in FIG. 9, explanations thereof are omitted.

According to the deployment of the aforementioned outfit center SD, effects similar to the effects (1) and (2) in the aforementioned virtual outfit center 90 can be expected.

Basic Supply Regulation Center SE

The basic supply regulation center SE is deployed in order to collectively regulating the basic supplies, for example, electric power, water, and steam, required for the industrial complex as a whole.

Since the specific functions of the basic supply regulation center SE are similar to those of the virtual basic supply regulation center 100 in the aforementioned other embodiments of the virtual center as shown in FIG. 9, explanations thereof are omitted herein.

According to the deployment of the aforementioned basic supply regulation center SE, effects similar to the effects (1) and (2) in the aforementioned virtual basic supply regulation center 100 can be expected.

Waste Recycle Center SF

The waste recycle center SF is deployed in order to collectively regulating the wastes discharged from the business entities (plants) A to D.

In the waste recycle center SF, a necessary number of the storage spaces in which the wastes discharged from the business entities (plants) A to D are classified and stored, the machines for the recycle treatment of the wastes, which can be recycled, among the classified wastes, etc are deployed. Then, the kinds of the wastes discharged from the business entities (plants) A to D are classified, and are stored in the corresponding storage spaces, and the kinds and the amounts of the wastes which can be used as the raw materials for other plants and the wastes which can be used as fuels are grasped, so that those are provided for each plant.

Therefore, according to the deployment of the aforementioned waste recycle center SF, the following effects can be expected.

(1) Since the necessary number of the storage spaces in which wastes discharged from the business entities (plants) A to D are classified and stored, the machines for the recycle treatment of the wastes, which can be recycled, among the classified wastes, etc., are deployed, every business entity (plant) A to D does not need to ensure the storage space and the machine for the recycle treatment, so that the waste can be decreased and the working ratios of the machines for the recycle treatment can be improved

(2) Since the kinds of the wastes discharged from the business entities (plants) A to D are classified, and are stored in the corresponding storage spaces, and the kinds and the amounts of the wastes which can be used as the raw materials for other plants and the wastes which can be used as fuels are grasped, the resources are effectively used in the industrial complex as a whole, and final industrial wastes can be decreased.

According to the aforementioned fourth embodiment, the following effects can be expected.

That is, each of effects as described above regarding each of the aforementioned service centers, i.e., from the analysis center to the waste recycle center, can be exhibited.

In addition, each service center is independent of the business entities (plants) A to D, so as not to be affected by physical and human-derived restrictions, etc., in each of the business entity. Therefore, each service center is deployed with a high degree of flexibility, and can match the functions and the performances required for the industrial complex with reliability.

In the aforementioned fourth embodiment, the facilities and the outfits, etc., required for the industrial complex as a whole are collectively deployed in each center, specifically, the analysis center SA, the customs affairs center SB, the conservation center SC, the outfit center SD, the basic supply regulation center SE, and the waste recycle center SF, although some facilities may be deployed in the business entities (plants) A to D while the regulation and the working status may be regulated in the center.

For example, regarding the analysis center SA, the business entities (plants) C and D have specialized analyzers, e.g., an analyzer for organic materials, and have specialized analytical techniques.

By these business entities (plants) C and D registering the business information, for example, the analyzers, the specialized analytical techniques, the working status thereof, and the fees (costs) of the analysis, in real time in the analysis center SA, these information (business information and booking registration information) can be grasped in real time with every terminal 10A to 10D in the business entities (plants) A to D, so that the request of analysis (booking) can be performed through the information network NW.

At this time, the fee (cost) is also automatically calculated in a similar manner to that of the analysis center SA in the aforementioned fourth embodiment, although regarding the payment, the costs are preferably counterbalanced among the business entities (plants) A to D at regular time intervals. Accordingly, the payment business can be advantageously decreased.

Furthermore, the delivery date may be automatically calculated based on the working status of the facility, so as to be confirmed at all times by each user.

Fifth Embodiment

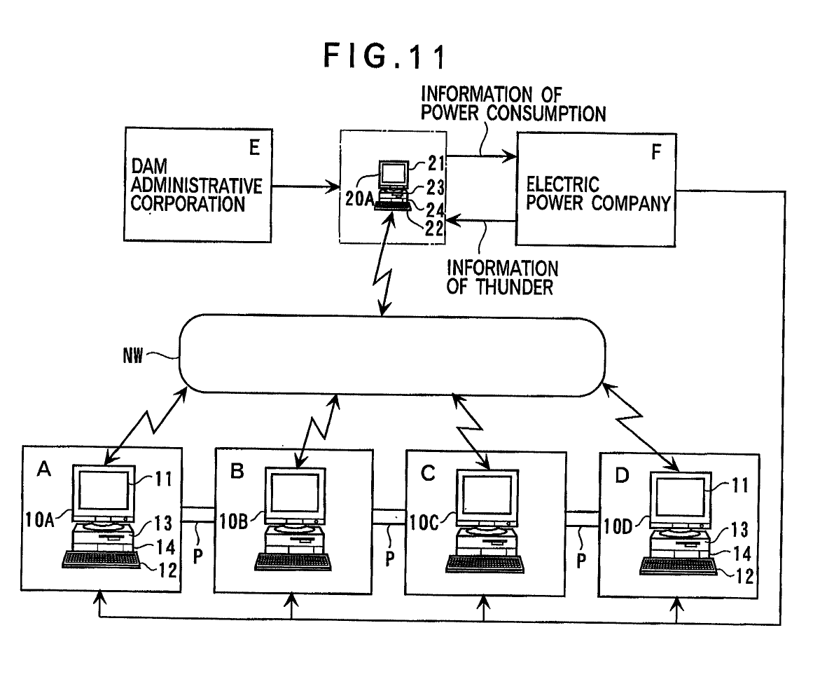

FIG. 11 shows a fifth embodiment. The fifth embodiment is an example of the industrial complex in which the raw materials and the services are interchanged. Herein, the raw material is a concept embracing every raw material for manufacturing products. Naphtha, reformed oils, kerosene, etc., manufactured from raw materials, and petrochemical basic products manufactured from naphtha, for example, ethylene, propylene, butadiene, benzene, toluene, and xylene, are raw materials for petrochemical derivatives. The services mean supply services of basic supplies, for example, water, electric power, steam, nitrogen, and oxygen.

This industrial complex is provided with a plurality of business entities A, B, C, D assembled in a predetermined area, a server 20A, an information network NW connecting those, a dam administrative corporation E connected with the server 20A so as to exchange the information, and an electric power company F connected with the server 20 so as to exchange the information.

In each of the business entities A to D, a plant is deployed, although not shown in the drawing, and terminals 10A, 10B, 10C, and 10D, respectively, for exchanging information with other business entities (plants) A to D and the server 20A through the information network NW, are deployed. Each of the terminals 10A to 10D is provided with a display device 11, an input device 12, a data processing device 14 including a memory device 13, etc., and the required kinds of the raw materials used by each of the business entities (plants) A to D and the amounts thereof, or the information regarding the basic supplies, for example, nitrogen, oxygen, water, electric power, and the steam, are inputted in real time.

The business entities (plants) A to D can be supplied with the raw materials and the services from each other through pipelines P, and furthermore, can be supplied with electric power from the electric power company F.

The server 20A is for exchanging the information with the terminals 10A to 10D deployed in the business entities (plants) A to D, so as to collect and regulate the information regarding the raw materials and the services.

The server 20A is provided with a display device 21, an input device 22, a data processing device 24 including a memory device 23, etc. The server 20A may be deployed in one of the business entities (plants) A to D, although may be deployed in another arbitrary place.

Herein, the aforementioned data processing device 24 is provided with functional devices, for example, a registration device for receiving the registration of the service provision status in at least one of the business entities (plants) A to D through an information network NW, a publishing device for publishing the registered service provision status to the other business entities (plants) A to D through the information network NW, an intermediating device for intermediating the service supplement between the business entities (plants) A to D publishing the service provision status and another business entities (plants) A to D, a calculator for calculating the optimum working status of the facility, and a calculator for calculating the fees (costs) generated due to the use of the service. Herein, those devices constitute a mutual service regulation system. In the memory device 23 as a storage medium, the programs regulating the systems performed by each of those devices are stored.

The interchange of the raw material (ethylene) and the interchanges of the basic supplies, for example, nitrogen and oxygen, water, electric power, and steam, will be specifically explained below.

Interchange of Ethylene

Regarding ethylene, the usage amounts of ethylene, per hour, are inputted with the terminals 10A to 10D deployed in the business entities (plants) A to D in real time. Then, the information is registered in the memory device 23 of the server 20A through the information network NW (function of the registration device).

For example, in the manufacture of petrochemical derivatives, e.g., ethylene, propylene, butadiene, benzene, toluene, and xylene, from naphtha, the server 20A determines the supply amounts to each of the business entities (plants) A to D based on the registered data, so that the maximum effect is produced at the minimum cost on the entirety of the industrial complex basis (function of the intermediating device), and publishes this, the registered data, etc., through the information network NW to each of the business entities (plants) A to D (function of the publishing device). The raw material supply maker can thereby perform the optimum operation based on the determined and published data, its own supply ability, and the performance of its own facility. If the supply amounts to each of the business entities (plants) A to D are determined in real time based on the registered data, the raw material maker can thereby perform the optimum operation with fine control of the facility. Therefore, the efficiency is improved on the entirety of the industrial complex basis.

Regarding ethylene, there are a way of liquefying and transferring ethylene with a pump and a way of transferring an overhead gas from rectifying tower as it is. Regarding the liquefaction, there are problems in that a great deal of energy and a heat source are necessary for re-vaporization. On the other hand, regarding the transfer of the gas, the demand amounts for ethylene must be grasped, although it is possible with the present system. The request for pressure supplement can be performed on the network.

Hitherto, since the ethylene supplier and the consumer have been in a one-to-one relationship, the pressure of the transferred gas had to be controlled to match the highest pressure among pressures required by consumers. Therefore, when a consumer A required large amounts of ethylene, the supply pressure had to be increased. According to the present invention, however, if another consumer B agrees to receive ethylene at a pressure lower than the current pressure, by decreasing the valve opening for the consumer B side and transferring the gas to the consumer A, the pressure required for the consumer A can be ensured without increase in supply pressure.

Interchange of Nitrogen and Oxygen

Regarding the nitrogen and the oxygen, data of the demand amounts therefor, current flow rates, pressures, etc., are inputted in real time with the terminals 10A to 10D deployed in the business entities (plants) A to D. Then, those data are registered in the memory device 23 of the server 20A through the information network NW (function of the registration device).

The server 20A calculates the optimum manufacturing methods for the nitrogen and the oxygen in consideration of the demand amounts of each of the business entities (plants) A to D, and publishes those, the registered data, etc., through the information network NW to each of the business entities (plants) A to D (function of the publishing device). For example, when there are a plurality of the nitrogen and the oxygen manufacture facilities in which air is cooled and separated so as to manufacture nitrogen and oxygen, the optimum working status of the nitrogen and the oxygen manufacture facilities are calculated (function of the calculator). The manufacturer can perform the optimum operation based on the determined data. If the optimum working status is determined in real time based on the registered data, the manufacturer can perform the optimum operation with fine control of the facility. Therefore, the efficiency is improved on the entirety of the industrial complex basis.

Interchange of Water

Regarding the water, data of the usage status, the amount of inventory, etc., are inputted in real time with the terminals 10A to 10D deployed in the business entities (plants) A to D. At this time, the operator may input at regular time intervals, although data may be automatically inputted by the water tanks being provided with sensors. Then, those data are registered in the memory device 23 of the server 20A through the information network NW (function of the registration device).

The server 20A grasps beforehand the necessary amount of the water for the entirety of the business entities (plants) A to D, controls the inventory at the required minimum amount for the industrial complex as a whole based on the aforementioned necessary amount and the registered amount of the inventory (function of the intermediating device), and publish those through the information network NW to the business entities (plants) A to D (function of the publishing device). Specifically, the water is transferred from the business entity having the surplus water to the business entity having a want of the water so that the inventory is controlled at the required minimum amount for the industrial complex as a whole. In particular, at the time of the water shortages, the working ratios of the facilities can be prevented from decreasing, by grasping the amounts of the inventory with each other and by transferring the surplus water.

In addition, the usage amount of the water used by each of the business entities (plants) A to D and the interchanged amount of the water are calculated (function of the calculator). At this time, by grasping the fees due to the usage amount of the water at one place while regulating the inventory of the water, the give and receive of cash regarding the interchange can be eliminated and the complicated works can be decreased.

Furthermore, the amount of the inventory may be controlled by grasping the impoundment of the dam in real time based on the information exchange at all times through the network with the dam administrative corporation E regulating the impoundment of the dam.

Interchange of Electric Power

Regarding the electric power, the data of the usage amount of the electric power, the scheduled usage amount, the local generation amount of the electric power, etc., are inputted in real time with the terminals 10A to 10D deployed in the business entities (plants) A to D. At this time, the operator may input at regular time intervals, although the usage amount of the electric power may be automatically inputted by the sensors being provided. Then, those data are registered in the memory device 23 of the server 20A through the information network NW (function of the registration device).

The server 20A determines the ratio of the purchased electric power and the locally generated electric power in order to minimize the cost on the entirety of the industrial complex basis, and publishes this, the registered data, etc., through the information network NW to each of the business entities (plants) A to D (function of the intermediary and publishing devices). In addition, the information of thunder is inputted by the electric power company, and is monitored. When the information of thunder is inputted the information of, for example, increase in ratio of the local generation of the electric power, increase in ratio of the store to the batteries, etc., are published through the information network NW to each of the business entities (plants) A to D.

Interchange of Steam

Regarding the steam, the data of the scheduled usage amount etc., are inputted in real time with the terminals 10A to 10D deployed in the business entities (plants) A to D. Then, those data are registered in the memory device 23 of the server 20A through the information network NW (function of the registration device).

The server 20A determines the working ratios of the boilers of each of the business entities (plants) A to D in order to generate required minim amount of the steam on a cost minimum basis from the viewpoint of the entirety of the industrial complex, and publishes this, the registered data, etc., through the information network NW to each of the business entities (plants) A to D (function of the publishing devices). At this time, the steam is transferred from the business entity having the surplus steam to the business entity having a want of the steam, so that the required minimum amount of the steam is generated on the entirety of the industrial complex basis (function of the intermediating device). Since supply of the steam is limited to the adjacent areas, the working ratios of the boilers are determined in consideration thereof

Sixth Embodiment

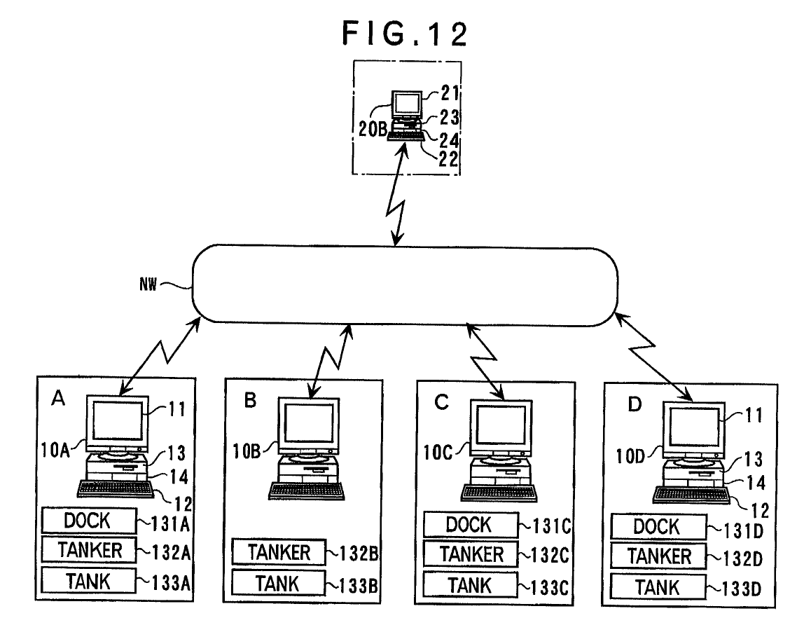

FIG. 12 shows a sixth embodiment. The sixth embodiment is an example of the industrial complex in which facilities herein, docks, tankers, and tanks) are interchanged. This industrial complex has functions of receiving the registrations of the facilities possessed by each of the business entities (plants) A to D, publishing the registered data, receiving the bookings of the facilities based on the disclosure, calculating the optimum working statuses of the facilities based on the booking registered data, and intermediating the uses of the services while automatically calculating the costs caused by the uses.

For example, the business entity (plant) A possesses a dock 131A, a tanker 132A, and a tank 133A, the business entity plant) B possesses a tanker 132B, and a tank 133B, the business entity (plant) C possesses a dock 131C, a tanker 132C, and a tank 133C, and the business entity (plant) D possesses a dock 131D, a tanker 132D, and a tank 133D.

Herein, the dock 131A has a high capacity, so that 3000 ton-class or more of ships, such as tankers, can come alongside the dock, and furthermore, smaller ships can also use the dock. The dock 131C has a relatively low capacity so as to be suitable for 3000 ton-lass or less of ships. The dock 131D is a dock at which so-called lightenning, that is, the loading from ship to ship, is possible. In addition to these data, the data of the dates and the times, the times of the unloading, etc., are registered in the memory device 23 of a server 20B through an information network NW with the terminals 10A, 10C, and 10D deployed in the business entities plants) A, C, and D, respectively.

The server 20B is provided with a registration device for receiving the registration of the information of the facilities (the service provision status) of each of the aforementioned business entities (plants) A to D, a booking registration device for receiving the booking of the aforementioned services through the information network NW a publishing device for publishing the registered service provision status and the booking registration status through the information network NW to the other business entities plants) A to D, a calculator for calculating the optimum working status of the facilities based on the booking data registered by the booking registration device, an intermediating device for intermediating the service supplement between the business entities (plants) A to D publishing the service provision status and another business entities (plants) A to D, and a calculator for calculating the fees (costs) generated due to the use of the service.

Interchange of Dock

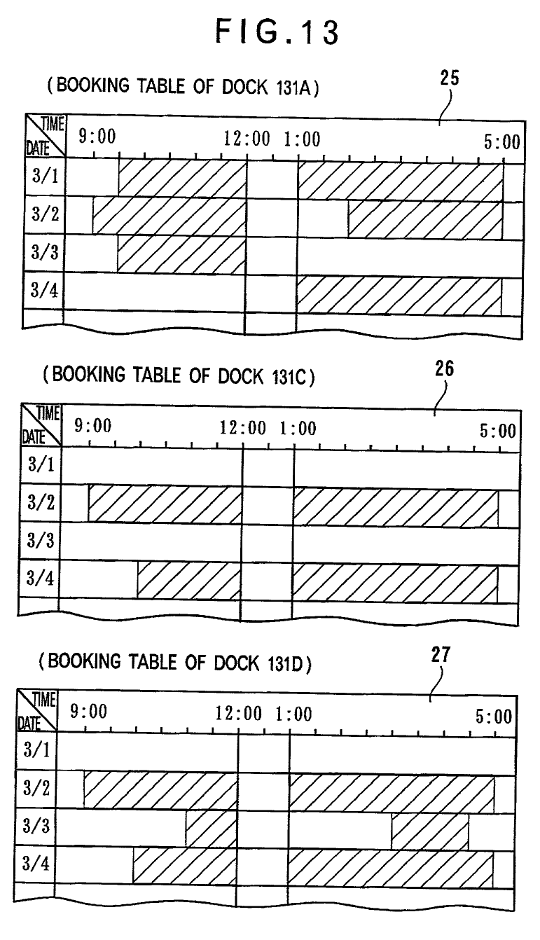

Regarding the dock, each of the business entities (plants) A, C, and D input the data of the capacity of its own docks, the dates and the times, the times of the unloading, etc., are inputted in real time with the terminals 10A, 10C, and 10D deployed in the business entities (plants) A, C, and D, respectively. These data are registered in the memory device 23 of the server 20B through the information network NW. For example, the use dates and times of each of the docks 131A, 131C, and 131D including the bookings are registered in the booking tables 25, 26, and 27, respectively, as shown in FIG. 13. In FIG. 13, the diagonally shaded areas indicate the booked time periods.

The registered service provision statuses (herein, the data regarding the facilities) and the booking registration status (the booking registration status of the booking tables 25, 26 and 27) are published through the information network NW to each of the aforementioned business entities (plants) A to D. Therefore, these data regarding the facilities and the booking registration status can be confirmed in real time with the terminals 10A to 10D in the business entities (plants) A to D, so that the booking of the facilities can be thereby performed.

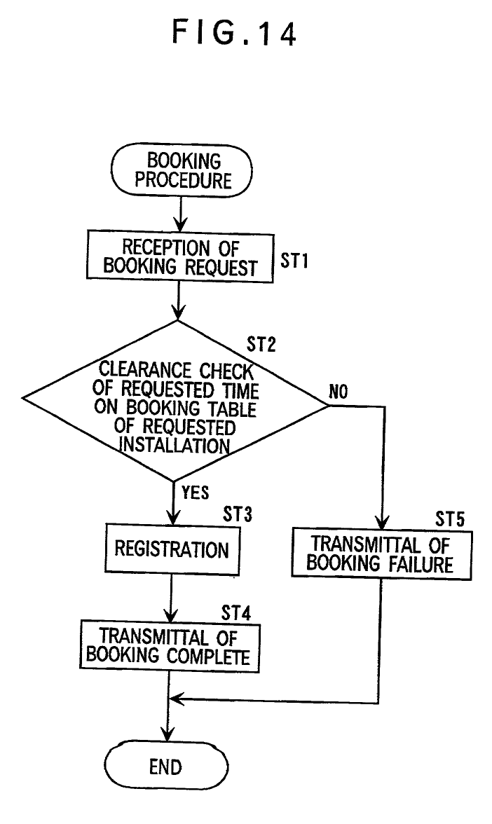

As shown in FIG. 14, when the booking registration device receives the booking request (ST1) from one of the business entities (plants) A to D, a clearance check of the requested time on booking tables 25 to 27 of the requested facility (ST2) is performed.

If there is a clearance, the booking registration is performed, that is, the booking is registered in the corresponding column of the booking tables 25 to 27 of the requested facility (ST3). Subsequently, a message of the booking completion is transmitted to one of the business entities (plants) A to D which has requested the booking (ST4).

On the other hand, if there is no clearance, a message of the booking failure is transmitted to one of the business entities (plants) A to D which has requested the booking (ST5). In this case, one of the business entities (plants) A to D which has received the message of the booking failure confirms the booking registration status, and requests another booking.

In the case in which the bookings are overlapped, for example, when the business entity B books the dock 131A for a certain period of time and the business entity D books the dock 131A for a large tanker which cannot come alongside the docks other than 131A for a overlapped period of time with that of the business entity B, the calculation is performed, so that the working status of the docks 131A and 131C become optimum on the entirety of the industrial complex basis (function of the calculator). In the calculation, in the case in which the load is a liquid, the cost of the transfer with the pipeline, etc., are taken into consideration and in the case in which the load is a solid, the cost of the transfer with the truck, the belt conveyer, etc., are taken into consideration, so that the most efficient working statuses of the docks 131A and 131C are calculated.

Since the dock 13 ID is a specialized dock, even if there is a prior booking, when a business entity desires the lightenning with a later booking, an adjustment among the other docks 131A and 131C is performed.

Regarding the use of the docks 131A, 131C, and 131D, the fees are calculated (function of the calculator). At the time, the calculation is performed in consideration of counterbalancing the fees based on the mutual uses of the docks 131A, 131C, and 131D among the business entities A, C, and D. In addition, the calculation is performed in consideration of counterbalancing the fees based on the uses of the facilities possessed by other business entities A to D. Accordingly, complicated works regarding the give and receive of cash can be decreased.

Each docks 131A, 131C, and 131D may be provided with a camera supervising the unloading, etc., so as to supervise on the network. In this case, since a plurality of docks 131A, 131C, and 131D can be monitored at one place, the saving labor in the supervision business becomes possible.

These networks may be connected with the government and municipal offices. Accordingly, for example, the coast guard can supervise the status of the works on each of the docks, and can grasp the navigation status of the ships coming alongside the docks in real time based on the booking status of each of the docks so that the time and the effort for compiling the navigation status of the ships can be saved.

Interchange of Tanker

Regarding the tanker, each of the business entities (plants) A to D input the data of the kinds, the capacity, the working status, etc., of its own tankers 132A to 132D in real time with the terminals 10A to 10D deployed in the business entities (plants) A to D. For example, ten tankers having a carrying capacity of 20 kiloliters of liquid, five trucks having a carrying capacity of 4 tons of load, the dates and the times of the uses, the destinations, etc., are inputted. These data are registered in the memory device 23 of the server 20A through the information network NW.

Thereafter, in a manner similar to that in the docks, the registered service provision status (herein, the data regarding the facilities) and the booking registration status are published through the information network NW to other business entities (plants) A to D. Therefore, the booking registration of the facilities can be performed with the terminals 10A to 10D in the business entities (plants) A to D, and furthermore, the intermediary and the calculation of the fees are performed at the time of the use.

Interchange of Tank

Regarding the tank, each of the business entities (plants) A to D input the data of the capacity, the dates and the times, the unloading times, etc., of its own tanks 133A to 133D in real time with the terminals 10A to 10D deployed in the business entities (plants) A to D. For example, four tanks having a storage capacity of 1,000 kiloliters of liquid, in use or not in use, the dates and the times of the uses, etc., are inputted. These data are registered in the registration device of the server 20A through the information network NW.

Thereafter, in a manner similar to that in the docks, the registered service provision status (herein, the data regarding the facilities) and the booking registration status are published through the information network NW to other business entities (plants) A to D. Therefore, the booking registration of the facilities can be performed with the terminals 10A to 10D in the business entities (plants) A to D, and furthermore, the intermediary and the calculation of the fees are performed at the time of the use.

Seventh Embodiment

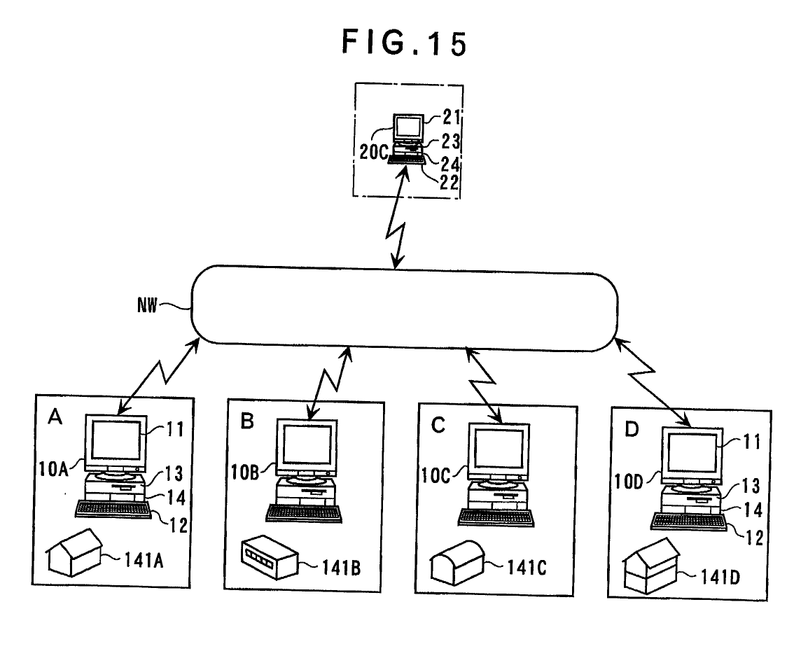

FIG. 15 shows a seventh embodiment. The seventh embodiment is an example of the industrial complex in which the accommodation facilities are interchanged. This industrial complex has functions of receiving the registrations of the accommodation facilities, for example, the welfare facilities, the dormitories, and the company's houses possessed by each of the business entities (plants) A to D, publishing the registered data, receiving the bookings of the accommodation facilities based on the disclosure, calculating the optimum working status of the accommodation facilities based on the booking registered data, and intermediating the uses of the services while automatically calculating the costs caused by the uses.

Specifically, each of the business entities (plants) A to D input the working status and the tenant status of its own accommodation facilities 141A to 141D in real time with the terminals 10A to 10D deployed in the business entities (plants) A to D. These data are registered in the registration device of the server 20A through the information network NW.

Thereafter, in a manner similar to that in the docks, the registered service provision status herein, the data regarding the facilities) and the booking registration status are published through the information network NW to other business entities (plants) A to D. Therefore, the booking registration of the facilities can be performed with the terminals 10A to 10D in the business entities (plants) A to D, and furthermore, the intermediary and the calculation of the fees are performed at the time of the use.

Eighth Embodiment

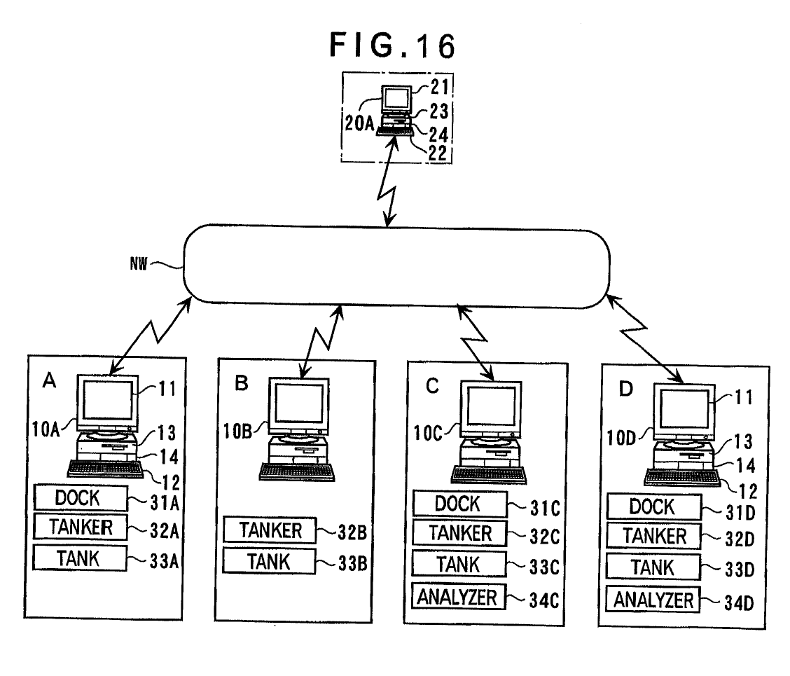

FIG. 16 shows an eighth embodiment. The eighth embodiment is an example of the shared operational information regulation system having functions of receiving the registrations of the operational information (working state information) regarding the facilities (herein, docks, tankers, tanks, and analyzers) possessed by each of the business entities constituting the initial complex, publishing (announcing) the registered data, receiving the bookings of the facilities based on the disclosure, calculating the optimum working status of the facilities based on the booking registered data, and intermediating the uses of the services while automatically calculating the costs caused by the uses.

This shared operational information regulation system is provided with a plurality of business entities A, B, C, D assembled in an industrial complex, a server 20A, and an information network NW connecting those. As the information network NW, a frame relay network provided among the business entities (plants) A to D is used.

In each of the business entities A to D, a plant, although not shown in the drawing, and various facilities are deployed, and furthermore, terminals 10A, 10B, 10C, and 10D, respectively, for exchanging the information with other business entities (plants) A to D and the server 20A through the information network NW, are deployed. Each of the terminals 10A to 10D is provided with a display device 11, an input device 12, a data processing device 14 including a memory device 13, etc. The operational information of the facilities possessed by each of the business entities A to D is inputted in real time with the input device 12. On the other hand, the operational information of the facilities of the business entities A to D registered in the server 20A is displayed on the display device 11. Herein, the input device includes a device in which the data are manually inputted, a device in which the data are directly captured from the apparatuses, etc.

The registration device for registering the operational information of the business entities and the announcement device for announcing the operational information registered with the registration device to each user are composed of the terminals 10A, 10B, 10C, and 10D deployed in the business entities A to D, the server 20A, and the information network NW connecting those.

Regarding the facility, for example, the business entity (plant) A is provided with a dock 131A, a tanker 132A, and a tank 133A, the business entity (plant) B is provided with a tanker 132B and a tank 133B, the business entity (plant) C is provided with a dock 131C, a tanker 132C, a tank 133C, and an analyzer 134C, and the business entity (plant) D is provided with a dock 131D, a tanker 132D, a tank 133D, and an analyzer 134D.

The server 20A is for exchanging the information with the terminals 10A to 10D deployed in the business entities (plants) A to D, so as to collect and regulate the operational information regarding the facilities, and is provided with a display device 21, an input device 22, a data processing device 24 including a memory device 23, etc. The server 20A may be deployed in one of the business entity (plants) A to D, although the server 20A may be deployed in another arbitrary place.

The aforementioned data processing device 24 is provided with a writing device which write the optional information (working state information) regarding the facilities of each of the business entity (plants) A to D into the memory device 23 through the information network NW, a booking registration device for receiving the registration of the booking of the aforementioned facilities, a publishing device for reading the operational information regarding facilities and the booking registration status from the memory device 23 and publishing those to the other business entities plants) A to D through the information network NW, a calculator for calculating the optimum working status of the facilities based on the booking data registered by the booking registration device, an intermediating device for intermediating the interchange of the facilities among the business entities (plants) A to D, and a calculator for calculating the fees (costs) generated due to the uses of the services. In the memory device 23 as a storage medium, the programs regulating the systems performed by each of those devices are stored.

Interchange of Dock

Regarding the dock, each of the business entities (plants) A, C, and D inputs the operational information of its own dock, for example, the arrival and the departure dates and times of the ships, the capacity of the ships, the kinds of the load, and other operational data, in real time with the terminals 10A, 10C, and 10D deployed in the business entities (plants) A, C, and D, respectively. These data are registered in the server 20A through the information network NW. For example, the dates and the times of the use including the bookings of each of the docks 131A, 131C, and 131D are registered in the booking tables 25, 26, and 27, respectively, as shown in FIG. 13. In FIG. 13, the diagonally shaded areas indicate the time periods of the registered booking.

The registered operational information of the docks and the booking registration (the booking registration status of the booking tables 25, 26 and 27) are published through the information network NW to each of the other business entities (plants) A to D. Therefore, these operational data regarding the facilities and the booking registration status can be confirmed in real time with the terminals 10A to 10D in the business entities (plants) A to D, so that the booking of the facilities can be thereby performed.

As shown in FIG. 14, when the booking registration device receives the booking request (ST1) from one of the business entities (plants) A to D, a clearance check of the requested time on the booking tables 25 to 27 with the requested facility (ST2) is performed.

If there is a clearance, the booking registration is performed, that is, the booking is registered in the corresponding column of the booking tables 25 to 27 of the requested facility (ST3). Subsequently, a message of the booking completion is transmitted to one of the business entities plants) A to D which has requested the booking (ST4).

On the other hand, if there is no clearance, a message of the booking failure is transmitted to one of the business entities (plants) A to D which has requested the booking (ST5). In this case, one of the business entities (plants) A to D which has received the message of the booking failure confirms the booking registration status, and requests another booking.

In the case in which the bookings are overlapped, for example, when the business entity B books the dock 131A for a certain period of time and the business entity D books the dock 131A for a large tanker, which cannot come alongside the docks other than the dock 131A, for a overlapped period of time with that of the business entity B, the server 20A calculates the most efficient working status of the docks 131A and 131C on the entirety of the industrial complex basis. In the calculation, in the case in which the load is a liquid, the cost of the transfer with the pipeline, etc., are taken into consideration and in the case in which the load is a solid, the cost of the transfer with the truck, the belt conveyer, etc., are taken into consideration, so that the most efficient working status of the docks 131A and 131C are calculated.

Provided the dock 131D is a specialized dock, that is, a dock at which the lightenning is possible, even if there is a prior booking, when a business entity desires the lightenning with a later booking, an adjustment among the other docks 131A and 131C is performed.

Regarding the use of the docks 131A, 131C, and 131D, the fees are calculated at the server 20A side. At this time, the calculation is performed in consideration of counterbalancing the fees based on the mutual uses of the docks 131A, 131C, and 13D among the business entities A, C, and D. In addition, the calculation is performed in consideration of counterbalancing the fees based on the uses of the facilities possessed by other business entities A to D. Accordingly, the complicated works regarding the give and receive of cash can be decreased.

Each docks 131A, 131C, and 13 ID may be provided with a camera as a remote monitoring device supervising the unloading, so as to supervise the image data of the camera with each terminal through the information network NW. In this case, since a plurality of docks 131A, 131C and 131D can be monitored at one place, the saving labor in the supervision business becomes possible. Furthermore, the remote control may be performed together with the supervision. In this case, the saving labor is further accelerated.

These networks may be connected with the government and municipal offices. Accordingly, for example, the coast guard can supervise the status of the works on each of the docks, and can grasp the navigation so of the ships coming alongside the docks in real time based on the booking status of each of the docks, so that the time and the effort for compiling the navigation status of the ships can be saved.

Interchange of Tanker

Regarding the tanker, each of the business entities (plants) A to D input the operational information of its own tankers 132A to 132D, for example, the data of the capacity of its own tanker, the kinds of the loads, the operation schedule (places and times), etc., in real time with the terminals 10A to 10D deployed in the business entities (plants) A to D. These data are registered in the server 20A through the information network NW.

Thereafter, in a manner similar to that in the docks, the registered data and the booking registration status are published through the information network NW to other business entities (plants) A to D. Therefore, the booking registration of the tankers can be performed with the terminals 10A to 10D in the business entities (plants) A to D, and furthermore, the intermediary and the calculation of the fees are performed at the time of the use.

Interchange of Tank

Regarding the tank, each of the business entities (plants) A to D input the operational information of its own tanks 133A to 133D, for example, the data of the number of the tanks 133A to 133D, the number of the tanks of not in use, the status of the use, the scheduled uses, the timings of the maintenance, the costs, etc., in real time with the terminals 10A to 10D deployed in the business entities (plants) A to D. These data are registered in the server 20A through the information network NW.

Thereafter, in a manner similar to that in the docks, the registered data and the booking registration status are published through the information network NW to other business entities (plants) A to D. Therefore, the booking registration of the facilities can be performed with the terminals 10A to 10D in the business entities (plants) A to D, and furthermore, the intermediary and the calculation of the fees are performed at the time of the use.

Interchange of Analyzer

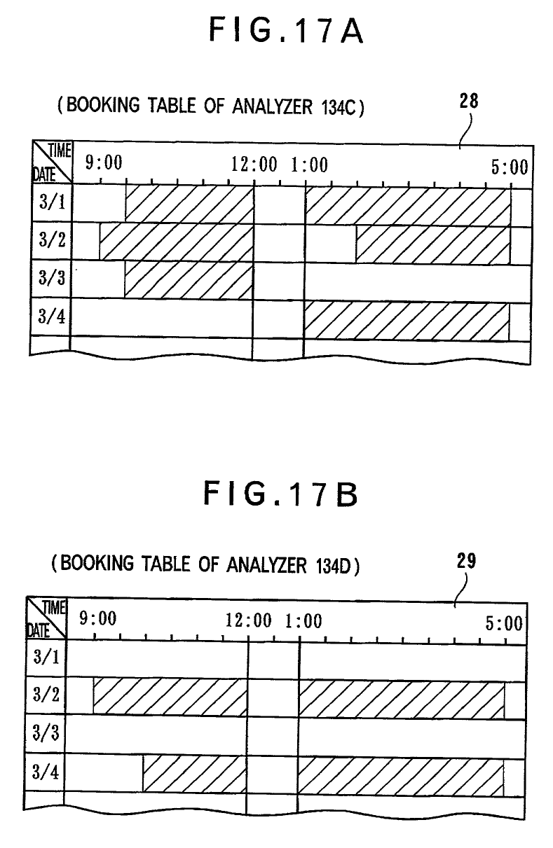

Regarding the analyzer, the business entities (plants) C and D input the data of the kinds, the analysis personnel, the analytical times, the booking statuses, the delivery dates, the costs, etc., of its own analyzers 134C and 134D in real time with the terminals 10C and 10D deployed in the business entities (plants) C and D. These data are registered in the server 20A through the information network NW. For example, the use dates and times of the analyzers 134C and 134D including the bookings are registered in the booking tables 28 and 29, respectively, as shown in FIG. 17. In FIG. 17, the diagonally shaded areas indicate the time periods covered with booking registrations.

The registered data and the booking registration status (the booking registration status of the booking tables 28 and 29) are published through the information network NW to each of the other business entities (plants) A to D. Therefore, these data regarding the analyzers and the booking registration status can be confirmed in real time with the terminals 10A to 10D in the business entities (plants) A to D, so that the booking of the analyzers can be thereby performed.

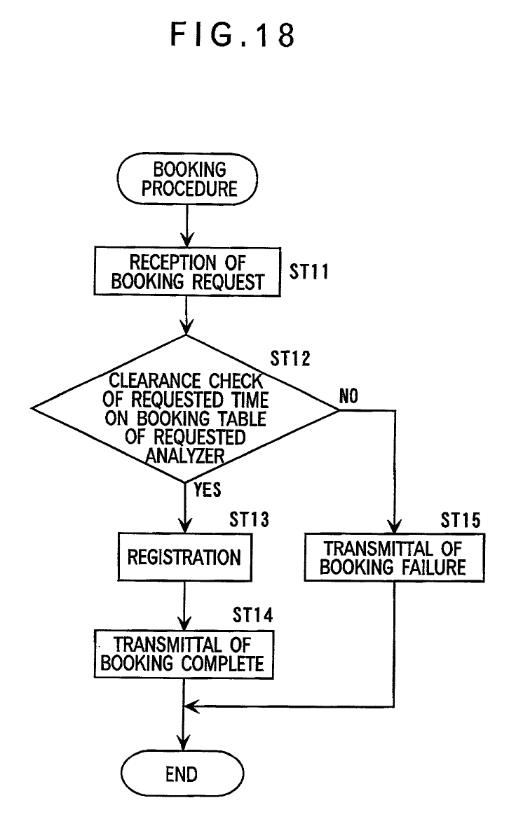

As shown in FIG. 18, when the booking registration device receives the booking request (ST11) from one of the business entities (plants) A to D, a clearance check on the requested time on the booking tables 28 and 29 of the requested analyzers 134C and 134D (ST12) is performed.

If there is a clearance, the booking registration is performed, that is, the booking is registered in the corresponding column of the booking tables 28 and 29 of the requested analyzers (ST13). Subsequently, a message of the booking completion is transmitted to one of the business entities (plants) A to D which has requested the booking (ST14).

On the other hand, if there is no clearance, a message of the booking failure is transmitted to one of the business entities (plants) A to D which has requested the booking (ST15). In this case, one of the business entities (plants) A to D which has received the message of the booking failure confirms the booking registration status, and requests another booking.

In the analysis and examination, for example, as shown in FIG. 2, an examination is performed based on an instruction, the resulting data are checked, and the calculation result of the fees (costs) and the data are reported.

If the delivery date can be automatically calculated based on the working status of the facility, and if each user can confirm this at all times, it is convenient for the users.

According to the aforementioned eighth embodiment, the following effects are expected

(1-1) Since the operational information regarding the facilities (docks, tankers, tanks, and analyzers) possessed by each of the business entities are announced to the users, the users can grasp the operational information regarding the facilities of each of the business entities. Therefore, the facilities (docks, tankers, tanks, and analyzers) possessed by each of the business entities can be shared and can be interchanged, so that the waste due to duplication of the facilities among the business entities can be decreased and the working ratio of each facility can be improved while the costs are decreased as a whole, and the surplus abilities are effectively used.

(1-2) The contents of the registrations and the booking registration status can be confirmed in real time with the terminals 10A to 10D in the business entities (plants) A to D and the booking for the use of the facility can be thereby performed, so that it is convenient for the users while the working ratio of the facility can be improved.

(1-3) Since the fees (costs) accompanying the use of the facilities are automatically calculated, the burden of handling the billings can be decreased. Normally, the fees are paid to the business entity taking charge of the analysis. Since the business entities (plants) A to D use the mutual facilities, by calculating the costs at regular intervals counterbalancing the costs among the business entities (plants) A to D, the handling regarding the payment can be decreased. That is, the business due to give and receive of cash is decreased and the paperwork is simplified. In addition, regarding the cost information, if a device for directly connecting to the bank is provided, by the automatic deposition into the bank account, the paperwork is further simplified.

(2) Regarding the interchange of the docks, since the operational information and the booking statuses of the docks 131A, 131C, and 131D are registered and published, the booking of the use can be performed with the terminals 10A to 10D deployed in the business entities (plants) A to D, and when the bookings are overlapped, the calculation is performed, so that the working status of the docks 131A, 131C, and 131D becomes most efficient on the entirety of the industrial complex basis, the docks 131A, 131C, and 131D can be efficiently operated on the entirety of the industrial complex basis.

(3) Regarding the interchange of the tankers, since the operational data of the capacity, the kinds of the loads, the operation schedule places and times), etc., of the tankers 132A to 132D are registered and published, and the booking registrations of the tankers 132A to 132D can be performed with the terminals 10A to 10D deployed in the business entities (plants) A to D, the tankers 132A to 132D can be efficiently operated on the entirety of the industrial complex basis.

(4) Regarding the interchange of tanks, since the data of the number of the tanks 133A to 133D, the number of the tanks not in use, the usage status, the scheduled uses, the timings of maintenance, the costs, etc., are registered and published, and the booking registrations ofthe tanks 133A to 133D can be performed with the terminals 10A to 10D deployed in the business entities (plants) A to D, the tanks 133A to 133D can be efficiently operated on the entirety of the industrial complex basis.

(5) Regarding the interchange of analyzers, in the advanced technology, for example, microanalysis, e.g., analysis of hazardous substances, expensive apparatuses and machines can be shared with the entirety of the industrial complex, so that the cost merit is increased. There are merits in that the analysis can be performed with small numbers of analysts and the analytical technique can be improved. In particular, regarding environmental analysis, since analysis items are common to the business entities (plants) A to D, the merit of the centralization is remarkable.

Ninth Embodiment

A ninth embodiment will be explained by using the aforementioned FIG. 11. The ninth embodiment is an example of the shared operational information regulation system having functions of receiving the registrations of the operational information regarding the raw materials and the basic supplies possessed by each of the business entities constituting the industrial complex, publishing the registered data, receiving the bookings of the raw materials and the basic supplies based on the disclosure, and furthermore, intermediating the interchange thereof while automatically calculating the costs generated in accordance with the interchange.

Herein, the raw material is a concept embracing every raw material for manufacturing products. Naphtha, reformed oils, kerosene, etc., manufactured from raw materials, and petrochemical basic products manufactured from naphtha, for example, ethylene, propylene, butadiene, benzene, toluene, and xylene, are the raw materials for the petrochemical derivatives. The services means supply services of basic supplies, for example, water, electric power, steam, nitrogen, and oxygen.

This shared operational information regulation system is provided with a plurality of business entities A, B, C, D assembled in a predetermined area, a server 20B, an information network NW connecting those, a dam administrative corporation E connected with the server 20B so as to exchange the information, and an electric power company F connected with the server 20B so as to exchange the information.

The server 20B and the terminals 10A to 10D deployed in the business entities A, B, C, D are the same as the server 20A and the terminals 10A to 10D in the eighth embodiment except that the operational information regarding the raw materials and basic supplies is handled. The business entities (plants) A to D can be supplied with the raw materials and the services through pipelines P from each other, and can also be supplied with the electric power from the electric power company F.

The interchange of the raw material (ethylene) and the interchange of the basic supplies, for example, nitrogen and oxygen, water, electric power, and steam, will be specifically explained below.

Interchange of Raw Material

Regarding the interchange of the raw material (ethylene), the operational information of the usage amounts of the raw material, per hour, herein the amount of ethylene, are inputted with the terminals 10A to 10D deployed in the business entities (plants) A to D in real time. Then, the information is registered in the server 20B through the information network NW.

For example, in the manufacture of petrochemical derivatives, e.g., ethylene, propylene, butadiene, benzene, toluene, and xylene, from naphtha, the server 20B determines the supply amounts to each of the business entities (plants) A to D based on the registered data, so that the maximum effect is produced at the minimum cost on the entirety of the industrial complex basis, and publishes this, the registered data, etc., through the information network NW to each of the business entities (plants) A to D. The raw material supply maker can thereby perform the optimum operation based on the determined and published data, its own supply ability, and the performance of its own facility.

Interchange of Basic Supplies

Regarding the interchange of the basic supplies (nitrogen and oxygen, water, electric power, and steam), the data of the demand amounts therefor, the current flow rates, the pressures, etc., are inputted in real time with the terminals 10A to 10D deployed in the business entities (plants) A to D. Then, those data are registered in the server 20B through the information network NW.

The server 20B calculates the optimum manufacturing methods for nitrogen and oxygen in consideration of the demand amounts of each of the business entities (plants) A to D, and publishes those, the registered data, etc., trough the information network NW to each of the business entities plants) A to D. For example, when there are a plurality of the nitrogen and the oxygen manufacture facilities in which air is cooled and separated so as to manufacture nitrogen and oxygen, the optimum working statuses of these nitrogen and oxygen manufacture facilities are calculated. The manufacturer can perform the optimum operation based on the determined data.

According to the aforementioned ninth embodiment, the following effects are expected.

Since the operational information regarding the raw materials (ethylene) and the basic supplies (nitrogen and oxygen, water, electric power, and steam, etc.) possessed by each of the business entities are announced to the users, the user can grasp the operational information regarding the raw materials and the basic supplies of each of the business entities. Therefore, the raw materials (ethylene) and the basic supplies (nitrogen and oxygen, water, electric power, and steam, etc.) possessed by each of the business entities can be shared and can be interchanged, so that the waste due to duplication of the raw materials and the basic supplies among the business entities can be decreased, and the costs are decreased as a whole, while the surplus abilities are effectively used.

Tenth Embodiment

A tenth embodiment will be explained by using FIG. 7. The tenth embodiment is an example of the shared operational information regulation system having functions of receiving registrations of the operational information regarding the fire fighting facilities possessed by each of the business entities constituting the industrial complex, publishing the registered data, and effectively using the fire fighting facilities based on the disclosure.

This shared operational information regulation system is provided with a plurality of business entities A, B, C, D, a server 20C, an information network NW connecting those in a manner similar to that in the eighth embodiment. The server 20C and the terminals 10A to 10D deployed in the business entities A, B, C, D are the same as the server 20A and the terminals 10A to 10D in the eighth embodiment except that the operational information regarding the fire fighting facilities is handled.

Regarding the fire fighting facilities, the operational information of the fire fighting facilities (kinds, numbers, etc.) possessed by each of the business entities (plants) A to D are inputted in real time with the terminals 10A to 10D deployed in the business entities (plants) A to D. For example, the operational information regarding the fire truck 41A and the chemical fire truck 42A is inputted from the terminal 10A, the operational information regarding the fire truck 41B and the ladder truck 43B is inputted from the terminal 10B, the operational information regarding the fire truck 41C is inputted from the terminal 10C, and the operational information regarding the fire truck 41D is inputted from the terminal 10D. Then, these data are registered in the server 20C through the information network NW.

The server 20C publishes the registered data regarding the fire fighting facilities possessed by each of the business entities (plants) A to D through the information network NW to each of the business entities (plants) A to D and also publish to the government and municipal offices (fire department). Therefore, for example, if a chemical fire has occurred in the business entity (plant) C, the business entity (plant) C can request the business entity (plant) A to call out the chemical fire truck 42A through the information network NW, and can request the other business entities (plants) B to D to call out the required number of the fire trucks.

According to the aforementioned tenth embodiment, the following effects are expected.

(1) Since the fire fighting facilities required for the industrial complex as a whole are ensured, and each of the business entities (plants) A to D does not need to ensure the fire fighting facilities for its own use, the number of the fire fighting facilities as a whole can be decreased. Therefore, the waste due to the duplication of the fire fighting facilities among the business entities (plants) A to D can be decreased, so that the costs can be decreased.

(2) Since these fire fighting facilities are distributed among the business entities (plants) A to D, this system can be realized by using the existing facility at the place as it is. That is, a new common fireguard center to centralize and put in these fire fighting facilities does not need to be constructed, so that this system can be economically realized. In addition, even if the fire fighting facilities are distributed among the business entities (plants) A to D, since these fire fighting facilities can be collectively regulated with the server 20B, the response to the disaster, for example, an occurrence of a fire, can be promptly and precisely performed The present invention is not limited to the constitutions in the aforementioned embodiments, but also includes the following embodiments.

For example, in the aforementioned embodiments, explanations were made on the operational information regarding the facilities, the operational information regarding the raw materials and basic supplies, and the operational information regarding the fireguard, although the information regarding the wastes, the information regarding the conservation implements and the office implements, and the information regarding the security may be registered and announced.

The information regarding the wastes means the kinds and the amounts of the wastes. Regarding the wastes, since the wastes of some business entities may be the raw materials of the products, according to the application of the present invention, the effective uses of the wastes may become possible. In addition, in the case in which the wastes are disposed at one place to rationally decrease the cost of the wastes, since the amounts of the wastes discharged from each of the business entities can be grasped in real time, there is an advantage that the operation control of the waste disposal facility can be performed with ease.

By the registration and the announcement of the information of visitors, etc., as the information regarding the fireguard, the fireguard system for the whole industrial complex can be realized.

In each of the aforementioned embodiments, the industrial complex was constituted with the operational information regarding the facilities, the operational information regarding the raw materials and basic supplies, and the operational information regarding the fireguard being treated as separate units, although the industrial complex may be constituted with every operational information published in the aforementioned embodiments, the information regarding the wastes, the information regarding the conservation implements and the office implements, and the information regarding the security being treated as a unit (system) in which those are collectively registered, regulated, and announced to the users.

In the aforementioned embodiments, the frame relay network was used as the information network, although optical cables may be used. When the fiber optics is used as the information network, larger amounts of information can be advantageously transmitted in high speed compared to that of the frame relay.

What is claimed is:

1. An industrial complex including a plurality of plants, the industrial complex having a service center for providing a service to at least one of said plants in response to a request therefrom.

2. The industrial complex according to claim 1, wherein said service center is independent of said plants.

3. The industrial complex according to claim 1, wherein said service center comprises at least one service section provided in said plants.

4. The industrial complex according to claim 3, wherein said service center comprises a plurality of service sections sharing mutually complementary function.

5. The industrial complex according to claim 4, wherein a virtual service center is composed of said plurality of service sections sharing the mutually complementary function.

6. The industrial complex according to claim 1, wherein said service comprises at least one of supply of a material, provision of a facility, and provision of a labor.

7. The industrial complex according to claim 1, wherein said service center has a request reception device for receiving a request for a service from each of said plants through an information network formed among said plants.

8. The industrial complex according to claim 1, wherein said service center has an announcement device for announcing a business information regarding said service to each of said plants through said information network formed among said plants.

9. A service center provided in an industrial complex having a plurality of plants, the service center providing a service for at least one of said plants in response to a request therefrom.

10. An industrial complex having a plurality of plants, the industrial complex comprising a publishing device for publishing the service provision status in at least one of said plants to the other plants.

11. The industrial complex according to claim 10, wherein said publishing device is constituted on an information network formed among said plants.

12. The industrial complex according to claim 10, further comprising an intermediating device for intermediating a service supplement between said plant publishing the service provision status and another plant.

13. The industrial complex according to claim 12, wherein said intermediating device is constituted on an information network formed among said plants.

14. A method for managing an industrial complex having a plurality of plants, the method comprising the steps of:
publishing the service provision status in at least one of said plants to the other plants; and
intermediating a service supplement between said plant publishing the service provision status and another plant.

15. A service regulation system for an industrial complex having a plurality of plants, comprising:
an announcement device for announcing a business information regarding said service to each of said plants through an information network formed among said plants;
a booking registration device for receiving a booking of a service reception; and
another announcement device for announcing a booking registration status to each user.

16. A service regulation system according to claim 15, further comprising a calculator for calculating costs caused by the use of said service.

17. A service regulation system according to claim 15, further comprising a calculator for calculating the optimum working status of a facility based on the booking data registered by said booking registration device.

18. A service regulation system for an industrial complex having a plurality of plants, comprising:
a registration device for receiving a registration of the service provision status in at least one of said plants;
a booking registration device for receiving a booking request for said service;
a publishing device for publishing said registered service provision status and said booking registration status to each of said plants; and
a calculator for calculating the optimum working status of a facility based on the booking data registered by said booking registration device.

19. The service regulation system according to claim 18, further comprising a calculator for calculating costs caused by the use of said service.

20. A shared operational information regulation system for an industrial complex including a plurality of assembled business entities, the system comprising:
a registration device for registering the operational information of said business entities; and
an announcement device for announcing said operational information registered by said registration device to each user.

21. The shared operational information regulation system according to claim 20, wherein at least one of said registration and said announcement is performed using an information network.

22. The shared operational information regulation system according to claim 20, wherein the working status of the facility possessed by each of said business entities is registered as said operational information.

23. A shared operational information regulation system according to claim 20, wherein said registration device comprises a frame relay network provided among said business entities, and a measured value of said working status of facility possessed by each of said business entities is registered through said frame relay network.

24. The shared operational information regulation system according to claim 20, further comprising a remote monitoring device for remotely monitoring the working status of a facility possessed by each of said business entities at a remote site.

25. The shared operational information regulation system according to claim 24, said working status of the facility monitored by said remote monitoring device is announced to each of said business entities through said announcement device as image information.

26. The shared operational information regulation system according to claim 21, wherein said information network uses an optical cable.
